(19) United States
(12) Patent Application Publication
(10) Pub. No.: US 2015/0205024 A1
(43) Pub. Date: Jul. 23, 2015

(54) OPTICAL LAMINATE

(71) Applicant: FUJIFILM Corporation, Tokyo (JP)

(72) Inventors: Chie SHINPUKU, Kanagawa (JP); Hidenori HAYASHI, Kanagawa (JP); Yoshiaki HISAKADO, Kanagawa (JP); Masato NAGURA, Kanagawa (JP)

(73) Assignee: FUJIFILM CORPORATION, Tokyo (JP)

(21) Appl. No.: 14/669,702

(22) Filed: Mar. 26, 2015

Related U.S. Application Data
(63) Continuation of application No. PCT/JP2013/072566, filed on Aug. 23, 2013.

(30) Foreign Application Priority Data
Sep. 28, 2012 (JP) 2012-218524
Mar. 29, 2013 (JP) 2013-073808

(51) Int. Cl. G02B 5/30; G02B 27/26; G02B 1/14

(52) U.S. Cl. CPC G02B 5/3016; G02B 5/3083; G02B 1/14; G02B 5/305; G02B 27/26

(57) ABSTRACT

The optical laminate includes a surface protection film; a transparent support; an optically anisotropic layer; an adhesive layer; and a release film in this order, and the optically anisotropic layer is a patterned optically anisotropic layer which includes a first phase difference region and a second phase difference region differing from each other in terms of the direction of an in-plane slow axis and in which the first and second phase difference regions are alternately disposed within a plane of the optically anisotropic layer, the transparent support contains a polymer material and has a thickness of 10 μm to 59 μm, and a Δ moisture content falls within a predetermined range. The optical laminate can be stuck on a display apparatus with high accuracy and can improve a vertical viewing angle of the display apparatus after being stuck on the display apparatus.

### CROSS-REFERENCE TO RELATED APPLICATIONS

This application is a Continuation of PCT International Application No. PCT/JP2013/072566 filed on Aug. 23, 2013, which claims priority under 35 U.S.C. §119(a) to Japanese Application No. 2012-218524 filed on Sep. 28, 2012 and Japanese Application No. 2013-073808 filed on Mar. 29, 2013. Each of the above application(s) is hereby expressly incorporated by reference, in its entirety, into the present application.

### BACKGROUND OF THE INVENTION

The present invention relates to an optical laminate used for an image display apparatus that can display stereoscopic images.

A 3D-image display apparatus displaying stereoscopic images requires an optical member which is for making a right-eye image and a left-eye image into, for example, circularly polarized images in opposite directions.

As the optical member, a patterned phase difference film is used in which regions differing from each other in terms of a slow axis, retardation, and the like are regularly arranged within the plane of the optical member.

For example, JP 2011-191756 A describes “an optical film including a support which contains a polymer having a moisture absorptivity of equal to or greater than 0.5%, and an optically anisotropic layer which has a first phase difference region and a second phase difference region differing from each other in terms of birefringence, and in which the first phase difference region and the second phase difference region are alternately patterned for each line” (claim 1). JP 2011-191756 A also describes a polarizing plate in which the optical film and a polarizing film are laminated on each other through an adhesive layer (claim 11).

Moreover, JP 2012-123040 A describes “a polarizing plate with a phase difference layer that is used on a visible side of a three-dimensional liquid crystal display apparatus, including a polarizer, a protective layer which is disposed on at least a visible side of the polarizer, and a phase difference layer which is disposed on a visible side of the protective layer disposed on the aforementioned visible side through an adhesive layer, in which the phase difference layer has a predetermined pattern consisting of a plurality of regions having slow axes in different directions respectively” (claim 1).

### SUMMARY OF THE INVENTION

Both JP 2011-191756 A and JP 2012-123040 A aim to decrease dimensional change of the patterned phase difference film (patterned phase difference layer) and thus reduce crosstalk. However, as a result of examination, the present inventors found that the techniques have the following problems.

That is, even though the dimensional change of the patterned phase difference film is decreased, if the film is stuck on a display apparatus with poor accuracy, the viewing angle (particularly, a vertical viewing angle) of the display apparatus markedly deteriorates after the film is stuck on the display apparatus.

Particularly, in recent years, from the viewpoint of increasing light utilization efficiency of a backlight, the aperture ratio of pixels of a liquid crystal display tends to be increased, and the width of a black matrix between the pixels tends to be narrowed. Consequentially, crosstalk has more easily occurred due to the misalignment between the patterned phase difference film and the pixels caused when the film is stuck on the display apparatus.

Therefore, the present invention aims to provide an optical laminate which can be stuck on a display apparatus with high accuracy and can improve a vertical viewing angle of the display apparatus after being stuck on the display apparatus.

In order to achieve the above object, the present inventors performed intensive research. As a result, they found that one of the factors decreasing the accuracy of sticking a patterned phase difference film on a display apparatus is positional deviation at the time of the sticking. Furthermore, from the viewpoint of reducing the positional deviation, for the purpose of improving the rigidity of an optical laminate, they investigated the relationship between the rigidity of the optical laminate and various physical properties of a transparent support containing a polymer material. As a result, surprisingly, they found that the film thickness may be further decreased, which may conflict with the improvement of the rigidity and the dependency of a predetermined Δ moisture content on the environment (mainly humidity) may be further decreased for reducing the positional deviation. Based on these findings, the inventors accomplished the present invention.

That is, the present invention provides the following [1] to [10].

[1] An optical laminate comprising:

a surface protection film;

a transparent support;

an optically anisotropic layer;

an adhesive layer; and

a release film in this order,

wherein the optically anisotropic layer is a patterned optically anisotropic layer which includes a first phase difference region and a second phase difference region differing from each other in terms of the direction of an in-plane slow axis and in which the first and second phase difference regions are alternately disposed within a plane of the optically anisotropic layer,

the transparent support contains a polymer material and has a thickness of 10 μm to 59 μm, and

a Δ moisture content defined by the following Equations (1) and (2) is equal to or less than 0.20% by mass.

Δ moisture content [% by mass]=a moisture content measured after the optical laminate is left in an environment of a temperature of 25° C. and a relative humidity of 40% for 336 hours, and then moved to an environment of a temperature of 25° C. and a relative humidity of 60% and left therein for 300 minutes (1)

a moisture content measured after the optical laminate is left in an environment of a temperature of 25° C. and a relative humidity of 40% for 336 hours.

The moisture content [% by mass]=an amount of water contained in the optical laminate/mass of the optical laminate (2)

[2] The optical laminate according to [1], wherein in the transparent support, an elastic modulus of a disposition direction in which the first and second phase difference regions of the optically anisotropic layer are alternately disposed is 1.5 GPa to 5.0 GPa.

[3] The optical laminate according to [1] or [2],

wherein in the transparent support, a rate of humidity-induced dimensional change in the disposition direction in which the first and second phase difference regions of the optically anisotropic layer are alternately disposed is 0.03% to 0.50%.

[4] The optical laminate according to any one of [1] to [3],

wherein a laminated portion comprising the transparent support and the optically anisotropic layer satisfies the following Expression (I),

|Rth(550)|≦120 nm, (I)

herein, Rth (550) is retardation (nm) in the thickness direction at a wavelength of 550 nm.

[5] The optical laminate according to any one of [1] to [4],

wherein the laminated portion comprising the transparent support and the optically anisotropic layer satisfies the following Expression (II),

|ΔRth(30% RH-80% RH)|≦30 nm, (II)

herein, ΔRth (30% RH-80% RH) is a difference between Rth (550) measured at a relative humidity of 30% and Rth (550) measured at a relative humidity of 80%.

[6] The optical laminate according to any one of [1] to [5],

wherein the polymer material contained in the transparent support contains at least cellulose acylate.

[7] The optical laminate according to any one of [1] to [6],

wherein the release film is a biaxially oriented polyester film having a thickness of 10 μm to 100 μm.

[8] The optical laminate according to any one of [1] to [7],

wherein the surface protection film is a biaxially oriented polyester film having a thickness of 20 μm to 100 μm.

[9] The optical laminate according to any one of [1] to [8],

wherein the optically anisotropic layer is formed of a composition containing a rod-like liquid crystal.

[10] The optical laminate according to any one of [1] to [9],

wherein the optically anisotropic layer is formed of a composition containing a discotic liquid crystal.

As described below, according to the present invention, it is possible to provide an optical laminate which can be stuck on a display apparatus with high accuracy and can improve the vertical viewing angle of the display apparatus after being stuck on the display apparatus.

### BRIEF DESCRIPTION OF THE DRAWINGS

FIG. 1 is a schematic cross-sectional view showing an example of an optical laminate of the present invention.

FIG. 2 is a schematic top view showing an example of an optically anisotropic layer.

FIG. 3 is a schematic top view showing another example of the optically anisotropic layer.

### DETAILED DESCRIPTION OF THE INVENTION

Hereinafter, the present invention will be described in detail. In the present specification, a range of numerical values that is indicated using “to” means a range in which numerical values before and after “to” are included therein as a lower limit and an upper limit. First, terms used in the present specification will be described.

Re (λ) and Rth (λ) represent in-plane retardation and thickness-direction retardation at a wavelength λ, respectively. By using KOBRA 21ADH or WR (manufactured by Oji Scientific Instruments), Re (λ) is measured by causing light having a wavelength of λ nm to enter a film in the normal line direction of the film. For selecting a measurement wavelength λ nm, wavelength selection filters can be replaced manually, or measured values can be converted by a program to perform the measurement. When a film to be measured can be expressed as a uniaxial or biaxial index ellipsoid, the Rth (λ) is calculated by the following method. The measurement method is partially used for measuring an average tilt angle of the side of an alignment film of discotic liquid crystal molecules in an optically anisotropic layer, which will be described later, and for measuring an average tilt angle of the side opposite to the aforementioned side.

For calculating Rth (λ), light having a wavelength of λ nm is caused to enter a film from a direction tilting to one side with steps of 10° to 50° respectively with respect to the normal line direction of the film, of which an in-plane slow axis (determined by KOBRA 21ADH or WR) is used as an axis of tilt (axis of rotation) (where there is no slow axis, any in-plane direction of the film is used as the axis of rotation), whereby the Re (λ) is measured at 6 points in total. Based on the value of retardation measured in this manner, a suppositional value of an average refractive index, and an input value of the film thickness, KOBRA 21ADH or WR calculates Rth (λ). In the above method, if the film has a direction in which the value of retardation becomes zero at a certain angle of tilt when the in-plane slow axis in the normal line direction is used as an axis of rotation, the sign of a value of retardation at an angle of tilt that is larger than the above angle of tilt is changed to a minus sign, and then Rth (λ) is calculated by KOBRA 21ADH or WR. It is also possible to measure a value of retardation in two directions that tilt at any angle by using the slow axis as the axis of tilt (axis of rotation) (when there is no slow axis, any in-plane direction of the film is used as the axis of rotation), and to calculate Rth by the following Formulae (A) and (B) based on the value measured as above, a suppositional value of an average refractive index, and an input value of the film thickness.

$$\begin{matrix}[ Formula 1 ] & \\ Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} & Formula ( A )\end{matrix}$$

Re (θ) in the above formula represents a value of retardation in a direction tilting at an angle θ from the normal line direction. Moreover, nx in Formula (A) represents a refractive index in the direction of an in-plane slow axis, ny represents a refractive index of an in-plane direction orthogonal to nx, and nz represents a refractive index of a direction orthogonal to nx and ny. d represents a thickness of the film.

Rth=((nx+ny)/2−nz)×d Formula (B)

When the film to be measured is a film which cannot be expressed as a uniaxial or biaxial index ellipsoid, that is, a film without a so-called optical axis, Rth (λ) is calculated by the following method. For calculating Rth (λ), light having a wavelength of λ nm is caused to enter a film from a direction tilting with steps varied by 10° from −50° to +50° respectively with respect to the normal line direction of the film, of which an in-plane slow axis (determined by KOBRA 21ADH or WR) is used as an axis of tilt (axis of rotation), whereby the Re (λ) is measured at 11 points in total. Based on the value of retardation measured in this manner, a suppositional value of an average refractive index, and an input value of the film thickness, KOBRA 21ADH or WR calculates Rth (λ). In the above measurement, as the suppositional value of an average refractive index, the values described in Polymer Handbook (JOHN WILEY & SONS. INC.) and in catalogs of various optical films can be used. If the value of average refractive index of a film is not known, the value can be measured by the Abbe's refractometer. The values of the average refractive index of main optical films are as follows: cellulose acylate (1.48), cycloolefin polymers (1.52), polycarbonate (1.59), polymethyl methacrylate (1.49), polystyrene (1.59). When suppositional values of these average refractive indices and the film thickness are input in KOBRA 21ADH or WR, the apparatus calculates nx, ny, and nz. From the calculated nx, ny, and nz, a value Nz is further calculated by Nz=(nx−nz)/(nx−ny).

In the present specification, “visible light” refers to light having a wavelength of 380 nm to 780 nm. Moreover, in the present specification, the measurement wavelength is 550 nm unless otherwise specified.

In addition, in the present specification, the angle (for example, “90°”, and the like) and the angular relationship (for example, “orthogonal”, “parallel”, “cross at 45°”, and the like) include a margin of error allowable in the technical field to which the present invention belongs. Specifically, the margin of error is within a range less than a precise angle ±10°. A difference between the precise angle and the angle in the angular relationship is preferably 5° or less and more preferably 3° or less.

[Optical Laminate]

The optical laminate of the present invention is an optical laminate having a surface protection film, a transparent support, an optically anisotropic layer, an adhesive layer, and a release film in this order,

in which the optically anisotropic layer is a patterned optically anisotropic layer which includes a first phase difference region and a second phase difference region differing from each other in terms of an in-plane slow axis direction and in which the first and second phase difference regions are alternately disposed within the plane thereof,

the transparent support contains a polymer material and has a thickness of 10 to 59 μm, and

a Δ moisture content defined by the following Equations (1) and (2) is equal to or less than 0.20% by mass.

Δ moisture content [% by mass]=a moisture content measured after the optical laminate is left in an environment of a temperature of 25° C. and a relative humidity of 40% for 336 hours, and then moved to an environment of a temperature of 25° C. and a relative humidity of 60% and left therein for 300 minutes (1)

a moisture content measured after the optical laminate is left in an environment of a temperature of 25° C. and a relative humidity of 40% for 336 hours.

The moisture content [% by mass]=an amount of water contained in the optical laminate/mass of the optical laminate (2)

Herein, “336 hours” in Equation (1) is a time (2 weeks) set on the assumption that it will take 336 hours for the amount of water (content of moisture) the optical laminate absorbs in an environment of a temperature of 25° C. and a relative humidity of 40% to be fully saturated. Accordingly, the optical laminate may be moved or the moisture content may be measured immediately after the elapse of 336 hours, or the optical laminate may be moved or the moisture content may be measured after the elapse of time equal to or longer than 336 hours (for example, 3 weeks).

Furthermore, the moisture content refers to a value measured by the Karl Fischer method and calculated by dividing the amount of water (g) by the mass (g) of a sample.

The optical laminate of the present invention having the aforementioned constitution can be stuck on a display apparatus with high accuracy and can improve the vertical viewing angle of the display apparatus after being stuck on the display apparatus.

Presumably, this is because when the optical laminate of the present invention is stuck on a display apparatus (preferably, immediately before the optical laminate is stuck on a display apparatus), the release film is peeled, and the optical laminate is stuck on an image display apparatus for displaying stereoscopic images through the adhesive layer, and as a result, positional deviation is inhibited.

The reason why the positional deviation is inhibited as above is unclear. However, presumably, this is because the thickness of the transparent support containing a polymer material is equal to or less than 59 μm, and thus, due to the existence of the surface protection film, the adhesive layer, and the release film disposed on and under the transparent support, the dimensional change of the transparent support caused by the change in temperature or humidity (particularly, humidity) is inhibited. Moreover, presumably, this is because the thickness of the transparent support is equal to or greater than 10 μm, and thus the strain resulting from elongation in the horizontal direction and contraction in the vertical direction at the time of sticking the optical laminate on the image display apparatus is inhibited.

In addition, presumably, this is because the Δ moisture content of the optical laminate is equal to or less than 0.20% by mass, and thus the dimensional change resulting from the difference between the environment in which the optical laminate is prepared and the environment in which the optical laminate is stuck on the image display apparatus, and particularly, the dimensional change resulting from the difference of humidity is inhibited.

Next, the entire constitution of the optical laminate of the present invention will be described by using drawings.

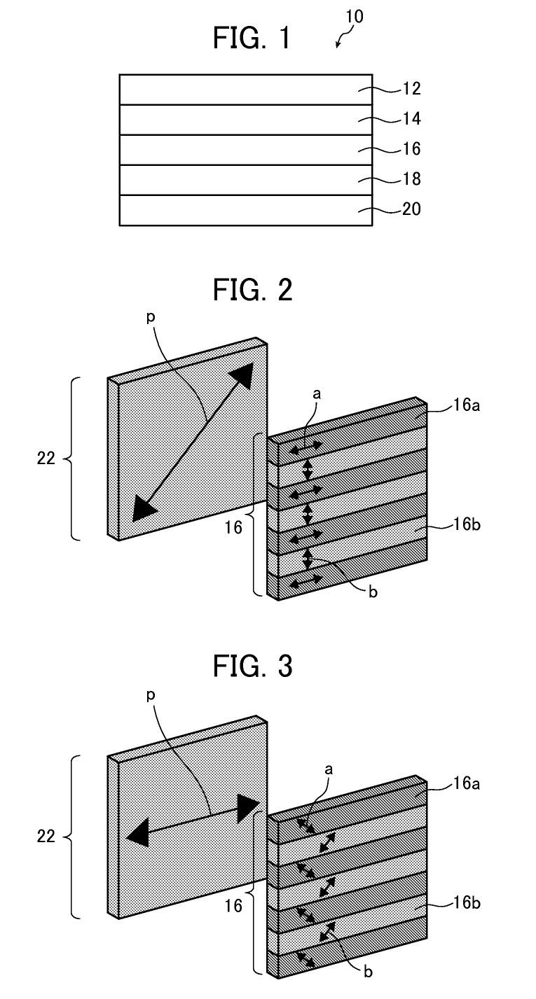

An optical laminate 10 shown in FIG. 1 has a surface protection film 12, a transparent support 14, an optically anisotropic layer 16, an adhesive layer 18, and a release film 20.

The optically anisotropic layer 16 shown in FIG. 1 is a patterned optically anisotropic layer which includes a first phase difference region and a second phase difference region differing from each other in terms of an in-plane slow axis direction and in which the first and the second phase difference regions are alternatively disposed within the plane thereof.

In the patterned optically anisotropic layer, the first and the second phase difference regions preferably have in-plane slow axes orthogonal to each other. Specifically, examples thereof include embodiments shown in FIGS. 2 and 3 in which in-plane slow axes a and b of first and second phase difference regions 16a and 16b of the optically anisotropic layer 16 are disposed such that they form an angle of ±45° with an absorption axis P of a visible side polarizing plate 22 in an image display apparatus for displaying stereoscopic images.

In an embodiment utilizing circular polarization, the Re of the first and second phase difference regions is preferably λ/4. Specifically, the Re is preferably 110 nm to 165 nm, and more preferably 120 nm to 145 nm.

When the transparent support is a phase difference film, the Re in the state in which the release film and the surface protection film have been removed from the entire optical laminate is preferably within the aforementioned range, including the Re of the transparent support.

For example, the transparent support is formed of a film with low Re, and specifically, the Re (550) of the transparent support is 0 nm to 10 nm.

Next, various members used in the optical laminate of the present invention will be specifically described.

<Surface Protection Film>

The optical laminate of the present invention has the surface protection film on the surface at the side opposite to the release film which will be described later.

The surface protection film is provided for protecting the surface until an image display apparatus for displaying stereoscopic images is prepared by using the optical laminate of the present invention.

As the surface protection film, it is possible to use the surface protection film for a polarizing plate described in JP 2007-304317 A. Specifically, a biaxially oriented polyester film can be suitably used.

In the present invention, the thickness of the surface protection film is not particularly limited, and is preferably 20 μm to 100 μm. The ratio (surface protection film/transparent support) between the thickness of the surface protection film and the thickness of the transparent support is preferably 0.3 to 10, and more preferably 0.4 to 1.5, since it is possible to further inhibit the positional deviation and to further improve the vertical viewing angle within the above range.

In the optical laminate of the present invention, the surface protection film can be provided on the side opposite to the optically anisotropic layer provided on the transparent support, by using an adhesive or the like.

<Transparent Support>

The optical laminate of the present invention has the transparent support which contains a polymer material and has a thickness of 10 μm to 59 μm.

Because the optical laminate of the present invention has the transparent support and the surface protective film, the adhesive layer, and the release film which will be described later, the optical laminate can be stuck on a display apparatus with high accuracy, and the vertical viewing angle of the display apparatus can be improved after the optical laminate is stuck on the display apparatus.

As described above, presumably, this is because when the optical laminate of the present invention is stuck on the display apparatus (preferably, immediately before the optical laminate is stuck on the display apparatus), the release film is released, and the optical laminate is stuck on the image display apparatus for displaying stereoscopic images through the adhesive layer, and as a result, the positional deviation is inhibited.

The thickness of the transparent support is preferably 20 μm to 50 μm, and more preferably 30 μm to 45 μm, since it is possible to further inhibit the positional deviation and to further improve the vertical viewing angle within the above range.

In the present invention, from the viewpoint of further inhibiting the positional deviation and further improving the vertical viewing angle, that is, from the viewpoint of further inhibiting the dimensional change of the transparent support due to the existence of the surface protection film, the adhesive layer, and the release film, in the transparent support, an elastic modulus in the disposition direction in which the first and second phase difference regions of the optically anisotropic layer are alternately disposed is preferably 1.5 GPa to 5.0 GPa, more preferably 1.7 GPa to 4.5 GPa, and even more preferably 2.0 GPa to 3.5 GPa. The elastic modulus can be controlled by the type of the polymer material, the type and amount of additives, and stretching.

Herein, for measuring the elastic modulus, a support sample (film) having a length of 150 mm and a width of 10 mm is prepared, the film is subjected to humidity conditioning for 24 hours at 25° C. and a relative humidity of 60%, and then based on the standard of 150527-3:1995, the elastic modulus at an initial sample length of 100 mm and a tensile rate of 10 mm/min is measured. From the initial slope of the stress-strain curve, the elastic modulus is calculated as a tensile elastic modulus.

Generally, the elastic modulus varies with the way of determine the length direction and the width direction of the support sample. In the present invention, the elastic modulus in the disposition direction is measured in which the first and second phase difference regions of the optically anisotropic layer in the support sample are alternately disposed.

In the present invention, provided that an elastic modulus in a direction in which the acoustic velocity is maximized is E1, and an elastic modulus in a direction orthogonal to the aforementioned direction is E2, from the viewpoint of reducing the dimensional change while maintaining the flexibility of the transparent support, a ratio (E1/E2) thereof is preferably 1.1 to 5.0, and more preferably 1.5 to 3.0.

In the present invention, for determining the direction in which the acoustic velocity (acoustic wave propagation velocity) is maximized, the transparent support is subjected to humidity conditioning for 24 hours at 25° C. and a relative humidity of 60%, and then by using an orientation measurement instrument (SST-2500: manufactured by NOMURA SHOJI CO., LTD.), a direction in which the propagation velocity of longitudinal wave vibration of ultrasonic pulses is maximized is determined as the aforementioned direction.

In the present invention, from the viewpoint of further inhibiting the positional deviation and further improving the vertical viewing angle, that is, from the viewpoint of further inhibiting the dimensional change of the transparent support due to the existence of the surface protection film, the adhesive layer, and the release film, in the transparent support, the rate of a humidity-induced dimensional change of the disposition direction in which the first and second phase difference regions of the optically anisotropic layer are alternately disposed is preferably 0.03% to 0.50%, more preferably 0.05% to 0.48%, and even more preferably 0.05% to 0.44%.

The rate of a humidity-induced dimensional change in the transparent support is a rate of change measured and calculated in the following manner.

First, a support sample (film) having a length of 25 cm (measurement direction) and a width of 5 cm that is cut to have the disposition direction, in which the first and second phase difference regions of the optically anisotropic layer are alternately disposed as described above, as the longitudinal direction is prepared. Pin hols are formed in the sample at an interval of 20 cm, and the sample is subjected to humidity conditioning for 24 hours at 25° C. and a relative humidity of 10%, and then the interval between the pin holes is measured using a pin gauge (the measured value is denoted as L₀).

Thereafter, the sample is subjected to humidity conditioning for 24 hours at 25° C. and a relative humidity of 80%, and then the interval between the pin hols is measured using a pin gauge (the measured value is denoted as L₁). By using the measured values, the rate of humidity-induced dimensional change is calculated using the following equation.

Rate of humidity-induced dimensional change(%)={(L₁−L₀)/L₀}×100

In the present invention, |Rth(550)| in a laminated portion comprising the transparent support and the optically anisotropic layer, which will be described later, is preferably equal to or less than 120 nm, more preferably equal to or less than 80 nm, and even more preferably equal to or less than 40 nm, since the horizontal viewing angle can be improved. Herein, the measuring method of Rth(550) is as described above.

The “laminated portion comprising the transparent support and the optically anisotropic layer, which will be described later” means a laminated portion not including the surface protection film, the adhesive layer, and the release film which are other essential constituents of the optical laminate of the present invention. Any constituent (for example, a hard coat layer or an antireflection layer) disposed between the surface protection film and the transparent support or any constituent (for example, an alignment film) disposed between the transparent support and the optically anisotropic layer is included in the laminated portion.

In the present invention, the absolute value of a difference between Rth (550) of the transparent support measured at a relative humidity of 30% and Rth (550) thereof measured at a relative humidity of 80%, that is, |ΔRth (30% RH-80% RH)| is preferably equal to or less than 30 nm, and more preferably less than 30 nm, since the horizontal viewing angle can be improved in an environment having a wide range of humidity.

Furthermore, for the same reason as above, |ΔRth (30% RH-80% RH)| in the laminated portion comprising the transparent support and the optically anisotropic layer, which will be described later, is preferably equal to or less than 30 nm, and more preferably less than 30 nm.

Examples of materials forming the support include cellulose-based polymers; acryl-based polymers having an acrylic acid ester polymer, such as polymethyl (meth)acrylate and lactone ring-containing polymer; thermoplastic norbornene-based polymers; polycarbonate-based polymers; polyester-based polymers such as polyethylene terephthalate and polyethylene naphthalate; styrene-based polymers such as polystyrene and an acrylonitrile/styrene copolymer (AS resin); polyolefin-based polymers such as polyethylene, polypropylene, and an ethylene/propylene copolymer; vinyl chloride-based polymers; amide-based polymers such as nylon and aromatic polyamide; imide-based polymers; sulfone-based polymers; polyethersulfone-based polymers; polyether ether ketone-based polymers; polyphenylene sulfide-based polymers; vinylidene chloride-based polymers; vinyl alcohol-based polymers; vinyl butyral-based polymers; arylate-based polymers; polyoxymethylene-based polymers; epoxy-based polymers; and polymers obtained by mixing these polymers together.

Furthermore, the support can be formed as a cured layer made of a UV curable resin or a thermosetting resin based on acryl, urethane, acrylic urethane, epoxy, or silicone.

Among the above materials, cellulose-based polymers (hereinafter, referred to as cellulose acylate), which have been conventionally used as transparent protective films of polarizing plates and are represented by triacetyl cellulose, can be preferably used, since the optical characteristics thereof are relatively easily controlled, depending on the type of various additives and stretching conditions selected and on the degree of substitution selected.

Moreover, it is also preferable to use acryl-based polymers, since they make it possible to reduce the Δ moisture content of the optical laminate and to stick the optical laminate on a display apparatus with higher accuracy.

Examples of the acryl-based polymers include polymethyl (meth)acrylate, lactone ring-containing polymers described in paragraphs [0017] to [0107] of JP 2009-98605 A, and the like.

Thermoplastic norbornene-based resins can also be preferably used, since they make it possible to reduce the Δ moisture content of the optical laminate and to stick the optical laminate on a display apparatus with higher accuracy. Examples of the thermoplastic norbornene-based resins include Zeonex and Zeonor manufactured by ZEON CORPORATION, Arton manufactured by JSR Corporation, and the like.

In the present invention, the support may contain at least one kind of plasticizer in addition to the aforementioned materials (particularly, cellulose acylate) forming the support. Here, because a plasticizer generally reduces the elastic modulus of a film, it is important to adjust the type of the plasticizer used and the amount thereof added. It is preferable to add a small amount of a sugar ester and a polycondensed oligomer-based plasticizer, since they make a contribution to the increase in the Lensile elastic modulus. Particularly, a sugar ester having an aromatic group and a polycondensed oligomer-based plasticizer are preferable, and the sugar ester is more preferable. For example, if a cellulose acylate film containing the sugar ester is subjected to stretching processing (preferably biaxial stretching processing), the tensile elastic modulus in MD and TD can be increased up to the above range. Moreover, the sugar ester also makes a contribution to the improvement of adhesion between the cellulose acylate film and a hard coat layer.

Examples of the sugar ester include sugar esters described in paragraphs [0022] to [0050] of JP 2012-215812 A and the like.

In the present invention, the preparation method of the support is not particularly limited. For example, the polymer film (particularly, the cellulose acylate film) can be prepared by various methods such as a solution casting method, a melt extrusion method, a calendar method, and a compression molding method.

Among these preparation methods, a solution casting method, and a melt extrusion method are preferable, and a solution casting method is particularly preferable. In the solution casting method, a film can be manufactured by using a solution (dope) obtained by dissolving cellulose acylate in an organic solvent. When the aforementioned additive is used, it may be added at any timing in the preparation process of the dope.

Specifically, it is possible to refer to the manufacturing method of a cellulose acylate film described in paragraphs [0219] to [0224] of JP 2006-184640 A, the solution film forming method for a polymer film described in paragraphs [0022] to and [0062] to [0088] and drawings in JP 2006-116936 A, and the like.

(Ultraviolet Absorber)

Being disposed on the visible side, the optical laminate of the present invention is easily influenced by external light, particularly, ultraviolet rays. Therefore, it is desirable to add an ultraviolet (UV) absorber to the polymer film (particularly, the cellulose acylate film) used as the transparent support or the like.

As the UV absorber, any of known substances that can exhibit ultraviolet absorptivity can be used. Among such ultraviolet absorbers, benzotriazole- or hydroxyphenyl triazine-based ultraviolet absorbers are preferable, since these exhibit a high degree of ultraviolet absorptivity and make it possible to obtain ultraviolet absorbing ability (ultraviolet cut-off ability) used in electronic image display apparatuses. Furthermore, in order to widen the absorption width of ultraviolet rays, two or more kinds of ultraviolet absorbers having different maximum absorption wavelengths can be concurrently used.

Particularly, as the UV absorber, a compound that has absorption in an ultraviolet region of 200 nm to 400 nm and reduces both the |Re (400)-Re (700)| and |Rth (400)-Rth (700)| of the film is preferable. For example, the UV absorber is used preferably in an amount of 0.01% by mass to 30% by mass with respect to solid contents of the cellulose acylate film.

In recent years, in liquid crystal display apparatuses such as televisions, laptops, and mobile terminals, in order to increase brightness with small power, optical members used in the liquid crystal display apparatuses have been required to have excellent transmittance. In this context, when a compound that has absorption in an ultraviolet region of 200 nm to 400 nm and reduces both the |Re (400)-Re (700)| and |Rth (400)-Rth (700)| of the film is added to the cellulose acylate film, the spectral transmittance of thereof is required to be excellent. In such a cellulose acylate film, a spectral transmittance at a wavelength of 380 nm is desirably equal to or greater than 45% and equal to or less than 95%, and a spectral transmittance at a wavelength of 350 nm is desirably equal to or less than 10%.

Moreover, from the viewpoint of volatility, the molecular weight of the UV absorber is preferably 250 to 1,000, more preferably 260 to 800, even more preferably 270 to 800, and particularly preferably 300 to 800. As long as the molecular weight is within the above range, the UV absorber may have a specific monomer structure, or an oligomer structure or a polymer structure in which a plurality of the monomer units is boded to each other.

Furthermore, it is preferable for the UV absorber not to volatilize in the process of dope casting and drying for preparing the cellulose acylate film.

Specific examples of the UV absorber of the cellulose acylate film include compounds described in paragraphs [0059] to [0135] of JP 2006-199855 A.

<Optically Anisotropic Layer>

The optically anisotropic layer in the optical laminate of the present invention is a patterned optically anisotropic layer which has the first phase difference region and the second phase difference region differing from each other in terms of an in-plane slow axis direction and in which the first and second phase difference regions are alternately disposed within the plane thereof.

The thickness of the patterned optically anisotropic layer is not particularly limited, and is preferably 0.1 μm to 10 μm and more preferably 0.5 μm to 5 μm.

Moreover, the patterned optically anisotropic layer preferably contains a liquid crystalline compound.

Examples of methods for forming the optically anisotropic layer containing a liquid crystalline compound include a method of fixing the liquid crystalline compound in the aligned state. At this time, as the method of fixing the liquid crystalline compound, for example, a method is preferable in which a liquid crystalline compound having an unsaturated double bond (polymerizable group) is used as the aforementioned liquid crystalline compound and fixed by polymerization. The optically anisotropic layer may have a single layer structure or a laminate structure.

The type of the unsaturated double bond contained in the liquid crystalline compound is not particularly limited. The unsaturated double bond is preferably functional groups that can cause an addition polymerization reaction, and among these, ethylenically unsaturated polymerizable groups or cyclic polymerizable groups are preferable. More specifically, preferable examples thereof include (meth)acryloyl groups, vinyl groups, styryl groups, allyl groups, and the like, and among these, (meth)acryloyl groups are more preferable.

Generally, according to the shape thereof, the liquid crystal compound is classified into a rod-like type and a discotic type, and each of these types is further classified into a low-molecular weight type and a polymer type. A polymer refers to a compound having a degree of polymerization of 100 or higher in general (Polymer physics—Phase transition dynamics, Masao DOI, p.2, Iwanami Shoten, Publishers., 1992). In the present invention, any of the liquid crystalline compounds can be used. However, it is preferable to use a rod-like liquid crystalline compound or a discotic liquid crystalline compound. Moreover, two or more kinds of rod-like liquid crystalline compounds, two or more kinds of discotic liquid crystalline compounds, or a mixture of a rod-like liquid crystalline compound and a discotic liquid crystalline compound may be used. For the aforementioned fixation of the liquid crystalline compound, the optically anisotropic layer is more preferably formed by using the rod-like liquid crystalline compound or the discotic liquid crystalline compound having the polymerizable group. Even more preferably, the liquid crystalline compound has two or more polymerizable groups in a single molecule. When the liquid crystalline compound is in the form of a mixture consisting of two or more kinds thereof, it is preferable that at least one kind of the liquid crystalline compounds has two or more polymerizable groups in a single molecule.

As the rod-like liquid crystalline compound, for example, those described in claim 1 of JP 11-513019 A or described in paragraphs [0026] to [0098] of JP 2005-289980 A can be preferably used. As the discotic liquid crystalline compound, for example, those described in paragraphs [0020] to [0067] of JP 2007-108732 A or paragraphs [0013] to [0108] of JP 2010-244038 A can be preferably used. However, the present invention is not limited to these.

In order to make the phase difference in the patterned optically anisotropic layer about λ/4, the alignment state of the liquid crystalline compound is controlled in some cases. In this case, when the rod-like liquid crystalline compound is used, the rod-like liquid crystalline compounds are preferably fixed in a state of being aligned horizontally, and when the discotic liquid crystalline compound is used, the discotic liquid crystalline compounds are preferably fixed in a state of being aligned vertically. In the present invention, when the “rod-like liquid crystalline compounds are horizontally aligned”, it means that a director of the rod-like liquid crystalline compounds is parallel to the surface of the layer, and when the “discotic liquid crystalline compounds are vertically aligned”, it means that the surface of the disk of the discotic liquid crystalline compounds is perpendicular to the surface of the layer. It is not required for the liquid crystalline compounds to be strictly parallel to or perpendicular to the surface of the layer, and the “parallel” or “perpendicular” means that the angle formed between the liquid crystalline compounds and the surface of the layer is within a range of ±20° from the accurate angle. The angle is preferably within ±5°, more preferably within ±3°, even more preferably within ±2°, and most preferably within ±1°.

In order to horizontally or vertically align the liquid crystalline compounds, an additive (alignment control agent) promoting the horizontal or vertical alignment may be used. As the additive, various known substances can be used.

In the present invention, examples of the method for forming the patterned optically anisotropic layer include the following preferable embodiments. However, the present invention is not limited thereto, and various known methods can be used for forming the patterned optically anisotropic layer.

A first preferable embodiment is a method of utilizing a plurality of actions that control the alignment of the liquid crystalline compounds and then making a predetermined alignment control action predominant by eliminating any of the actions by using an external stimulus (thermal processing or the like). In such a method, for example, by a composite action of alignment controllability resulting from an alignment film and alignment controllability of an alignment control agent added to the liquid crystalline compounds, the liquid crystalline compounds are aligned in a predetermined state and fixed, thereby forming one phase difference region. Thereafter, by using an external stimulus (thermal processing or the like), any of the actions (for example, the action resulting from the alignment control agent) is eliminated such that the other alignment control action (the action resulting from the alignment film) becomes predominant. In this way, the liquid crystalline compounds are aligned in the other state and fixed, thereby forming the other phase difference region. This method is specifically described in paragraphs [0017] to [0029] of JP 2012-008170 A, and the content of which is incorporated into the present specification as reference.

A second preferable embodiment is an embodiment of utilizing a patterned alignment film. In this embodiment, patterned alignment films having different types of alignment controllability are formed, and liquid crystalline compounds are disposed on the films and aligned. The state the liquid crystalline compounds are aligned varies with the alignment controllability of each of the patterned alignment films. By fixing the respective alignment states, patterns of the first and second phase difference regions corresponding to the patterns of the alignment films are formed. The patterned alignment films can be formed by means of a printing method, mask rubbing performed on a rubbing alignment film, mask exposure performed on a photo-alignment film, and the like. A method utilizing a printing method is preferable, since the method does not require large-scale equipment and the films are easily manufactured by the method. This method is specifically described in paragraphs [0166] to [0181] of JP 2012-032661 A, and the content of which is incorporated into the present specification as reference.

A third preferable embodiment is an embodiment of adding, for example, a photo-acid generator to an alignment film. In this embodiment, a photo-acid generator is added to an alignment film, and by pattern exposure, the photo-acid generator is decomposed. As a result, a region in which acidic compounds are generated and a region in which the compounds are not generated are formed. In a portion not irradiated with light, the photo-acid generator substantially remains as is without being decomposed; the alignment state is controlled by the interaction among the material of the alignment film, the liquid crystalline compounds, and the alignment control agent which is added if necessary; and the liquid crystalline compounds are aligned in a direction in which the slow axis thereof becomes orthogonal to a rubbing direction. When the alignment film is irradiated with light, and thus acidic compounds are generated, the aforementioned interaction is no longer predominant, and the alignment state is controlled by the rubbing direction of a rubbing alignment film. As a result, the liquid crystalline compounds are aligned in a state in which the slow axis thereof becomes parallel to the rubbing direction. As the photo-acid generator used in the alignment film, a water-soluble compound is preferably used. Examples of usable photo-acid generators include the compounds described in Prog. Polym. Sci., vol. 23, p.1485 (1998). As the photo-acid generator, pyridinium salts, iodonium salts, and sulfonium salts are particularly preferably used. The aforementioned method is specifically described in Japanese Patent Application No. 2010-289360, and the content of which is incorporated into the present specification as reference.

<Adhesive Layer>

The optical laminate of the present invention has an adhesive layer which is for bonding the aforementioned optically anisotropic layer and transparent support to the visible side polarizing plate in the image display apparatus for displaying stereoscopic images.

The adhesive layer is not particularly limited as long as it has adhesive strength sufficient for practical use. For example, it is possible to suitably use the adhesive layer for an optical film described in JP 2012-116986 A.

In the present invention, the thickness of the adhesive layer is not particularly limited, and is preferably 15 μm to 30 μm. A ratio (adhesive layer/transparent support) between the thickness of the adhesive layer and the thickness of the transparent support is preferably 0.25 to 3 and more preferably 0.3 to 1.0, since it is possible to further inhibit the positional deviation and to further improve the vertical viewing angle in this range.

<Release Film>

The optical laminate of the present invention has a release film in addition to the adhesive layer.

The release film is peeled when the image display apparatus for displaying stereoscopic images is prepared using the optical laminate of the present invention, that is, when the aforementioned adhesive layer is stuck on the polarizing film.

As the release film, the polyester film for being stuck on a polarizing film described in JP 2002-40249 A can be used. Specifically, a biaxially oriented polyester film can be suitably used.

In the present invention, the thickness of the release film is not particularly limited, and is preferably 10 μm to 100 μm. A ratio (release film/transparent support) between the thickness of the release film and the thickness of the transparent support is preferably 0.16 to 10 and more preferably 0.4 to 1.5, since it is possible to further inhibit positional deviation and to further improve the vertical viewing angle in this range.

In the optical laminate of the present invention, the adhesive layer and the release film can be provided in a manner in which the adhesive layer is formed on the release film and then stuck on the side of the transparent support where the optically anisotropic layer has been formed.

<Other Layers>

(Alignment Film)

In the optical laminate of the present invention, an alignment film, which is for forming the optically anisotropic layer, may be formed between the transparent support and the optically anisotropic layer.

Generally, alignment films contain polymers as a main component. The polymer materials for the alignment films are described in a large number of documents, and there are a large number of commercially available products thereof. As the polymer materials used, polyvinyl alcohol or polyimide and derivatives thereof are preferable. Particularly, modified or unmodified polyvinyl alcohol is preferable. Regarding the alignment film usable in the present invention, it is possible to refer to the modified polyvinyl alcohol described in line 24 on page 43 to line 8 on page 49 of WO 01/88574A1 and in paragraphs [0071] to [0095] of JP 3907735 B.

It is preferable for the alignment film to have a small thickness. However, from the viewpoint of imparting alignment ability for forming the optically anisotropic layer and from the viewpoint of forming the optically anisotropic layer having a uniform thickness by absorbing surface unevenness of the support, the alignment film needs to be thick to some extent. Specifically, the thickness of the alignment film is preferably 0.01 μm to 10 μm, more preferably 0.01 μm to 1 μm, and even more preferably 0.01 μm to 0.5 μm,

In the present invention, it is also preferably to use a photo-alignment film. The photo-alignment film is not particularly limited, and those described in paragraphs [0024] to [0043] of WO 2005/096041, LPP-JP265CP (trade name) manufactured by Rolic Technologies Ltd., and the like can be used.

(Hard Coat Layer/Antireflection Layer)

On the surface, which is at the side opposite to the side of liquid crystal cells, of the optical laminate of the present invention, a functional film such as an antireflection layer is preferably disposed. Such an optional functional film is disposed between the transparent support and the surface protection film.

Particularly, in the present invention, an antireflection layer composed of at least a light scattering layer and a low-refractive index layer which are laminated in this order on the transparent support or an antireflection layer composed of a middle-refractive index layer, a high-reflective index layer, a low-refractive index layer which are laminated in this order on the transparent support is suitably used. This is because such an antireflection layer can effectively prevent the occurrence of flicker resulting from the reflection of external light particularly when a 3D image is displayed. The antireflection layer may further have a hard coat layer, a forward scattering layer, a primer layer, an antistatic layer, an undercoat layer, a protective layer, or the like. The respective layers constituting the antireflection layer arc specifically described in paragraphs [0182] to [0220] of JP 2007-254699 A, and preferable characteristics, preferable materials, and the like described in the documents are also applied to the antireflection layer usable in the present invention.

### EXAMPLES

The present invention will be more specifically described based on the following examples. The materials, the amount and proportion thereof used, the content of processing, the procedure of processing, and the like described in the following examples can be appropriately changed within a scope that does not depart from the gist of the present invention. Therefore, the scope of the present invention is not restricted by the following examples.

### Example 1

### Preparation of Transparent Support

(Preparation of Cellulose Acylate Dope)

The following composition was put into a mixing tank and stirred such that the respective components were dissolved, thereby preparing a cellulose acylate solution.

In the makeup of the following components, the amount of the plasticizer and the ultraviolet absorber added is represented by “part by mass” with respect to 100 parts by mass of cellulose acylate (cellulose acetate having a degree of acetyl substitution of 2.88).

(Makeup of Components)

| | |
|---|---|
| Plasticizer (P-1) | 12 parts by mass |
| Ultraviolet absorber (UV-1) | 1.8 parts by mass |
| Ultraviolet absorber (UV-2) | 0.8 parts by mass |

The makeup of the solvent is as follows. A cellulose acylate dope was prepared by adjusting concentration thereof such that the concentration of cellulose acetate became 17% by mass.

(Makeup of Solvent)

| | |
|---|---|
| Methylene chloride (a first solvent) | 92 parts by mass |
| Methanol (a second solvent) | 8 parts by mass |

Furthermore, the following matting agent dispersion was added in amount of 3.6 parts by mass to the cellulose acylate dope.

(Matting Agent Dispersion)

| | |
|---|---|
| Silica particle dispersion | 0.7 parts by mass |
| (average particle size of 16 nm) | |
| Methylene chloride (a first solvent) | 75.5 parts by mass |
| Methanol (a second solvent) | 6.5 parts by mass |
| The aforementioned dope | 17.3 parts by mass |

(Preparation of Transparent Cellulose Acylate Support)

A mixed solution consisting of the cellulose acylate dope and the matting agent dispersion was casted onto a band at 20° C. from a casting outlet. In a state of containing about 20% by mass of solvent, the support was peeled, and the support was dried in a state in which both ends thereof in the width direction were fixed with tenter clips. Thereafter, the support was transported between rolls of a thermal processing apparatus and then dried further, thereby preparing a transparent cellulose acylate support having a film thickness shown in the following Table 1.

Moreover, a film sample having the same makeup as the transparent cellulose acylate support was prepared, and the elastic modulus and the humidity-induced dimensional change thereof were measured by the aforementioned methods. The results are shown in the following Table 1.

The plasticizer (P−1) is a mixture of triphenyl phosphate (TPP)/biphenyl diphenyl phosphate (BDP)=2/1 (mass ratio).

The ultraviolet absorber (UV-1) and the ultraviolet absorber (UV-2) are compounds represented by the following formulae, respectively.

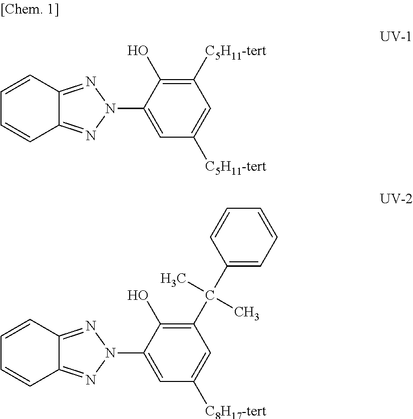

<Alkali Saponification Processing>

The transparent cellulose acetate support was passed through a dielectric heating roll at a temperature of 60° C. such that the temperature of the film surface increased to 40° C. Thereafter, one surface of the film was coated with an alkaline solution having the makeup described below in a coating amount of 14 ml/m² by using a bar coater, and the film was transported for 10 seconds under a steam-type far-infrared heater manufactured by NORITAKE CO., LIMITED. heated at 110° C. Subsequently, the film was coated with pure water in an amount of 3 ml/m² by similarly using a bar coater. Then, an operation of washing the film with water by using a fountain coater and blowing off the water by using an air knife was repeated three times. Then, the film was dried by being transported for 10 seconds in a drying zone at 70° C., thereby preparing a transparent cellulose acetate support having undergone alkali saponification processing.

(Makeup of Alkaline Solution)

| | | |
|---|---|---|
| Sodium hydroxide | 4.7 | parts by mass |
| Water | 15.8 | parts by mass |
| Isopropanol | 63.7 | parts by mass |
| Surfactant SF-1: C₁₄H₂₉O (CH₂CH₂O)₂₀H | 1.0 | part by mass |
| Propylene glycol | 14.8 | parts by mass |
| <Formation of rubbing alignment film> | | |

The surface, which has undergone the saponification processing, of the support prepared as above was continuously coated with a coating liquid for a rubbing alignment film having the makeup described below by using a #8 wire bar. The support was dried with hot air at 60° C. for 60 seconds and then with hot air at 100° C. for 120 seconds, thereby forming an alignment film. Thereafter, a stripe mask, in which a transmission portion has a horizontal stripe width of 100 μm and a shield portion has a horizontal stripe width of 300 μm, was disposed on the rubbing alignment film, and then the film was irradiated with ultraviolet rays for 4 seconds in the air at room temperature by using an air-cooled metal halide lamp (manufactured by EYE GRAPHICS Co., Ltd.) having an illuminance of 2.5 mW/cm² in a UV-C region so as to decompose the photo-acid generator and generate acidic compounds. In this manner, an alignment film for the first phase difference region was formed. Subsequently, the support was subjected to rubbing processing while being caused to reciprocate once in one direction at 500 rpm, thereby preparing a transparent support with a rubbing alignment film. The film thickness of the alignment film was 0.5 μm.

(Makeup of Coating Liquid for Forming Alignment Film)

| | |
|---|---|
| Polymer material for alignment film (polyvinyl alcohol | 3.9 parts by mass |
| PVA 103, manufactured by KURARAY CO., LTD.) | |
| Photo-acid generator (S-2) | 0.1 parts by mass |
| Methanol | 36 parts by mass |
| Water | 60 parts by mass |

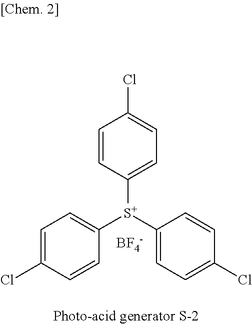

<Formation of Patterned Optically Anisotropic Layer>

The following composition for an optically anisotropic layer was prepared and then filtered through a filter made of polypropylene having a pore size of 0.2 μm, thereby preparing a coating liquid for an optically anisotropic layer. The support was coated with the coating liquid in a coating amount of 4 ml/m² by using a bar coater. Thereafter, the support was dried for 2 minutes at a film surface temperature of 110° C. to form a liquid crystal phase and uniformly align the discotic liquid crystals. Then the support was cooled to 100° C. and irradiated with ultraviolet rays for 20 seconds in the air by using an air-cooled metal halide lamp of 20 mW/cm² (manufactured by EYE GRAPHICS Co., Ltd.) to fix the alignment state, thereby forming a patterned optically anisotropic layer. In the portion (the first phase difference region) having undergone mask exposure, the discotic liquid crystals (DLC) were vertically aligned such that the slow axis direction became parallel to the rubbing direction, and in the unexposed portion (the second phase difference region), the DLCs were vertically aligned such that the slow axis direction became orthogonal to the rubbing direction. The film thickness of the optically anisotropic layer was 0.8 m.

(Makeup for Optically Anisotropic Layer)

| | | |
|---|---|---|
| Discotic liquid crystal E-1 | 100 | parts by mass |
| Alignment agent for alignment film interface (II-1) | 3.0 | parts by mass |
| Alignment agent for air interface (P-1) | 0.4 | parts by mass |
| Photopolymerization initiator (Irgacure 907, | 3.0 | parts by mass |
| manufactured by Ciba Specialty Chemicals, Inc.) | | |
| Sensitizer (Kayacure DETX, manufactured by Nippon | 1.0 | part by mass |
| Kayaku Co., Ltd.) | | |
| Methyl ethyl ketone | 400 | parts by mass |

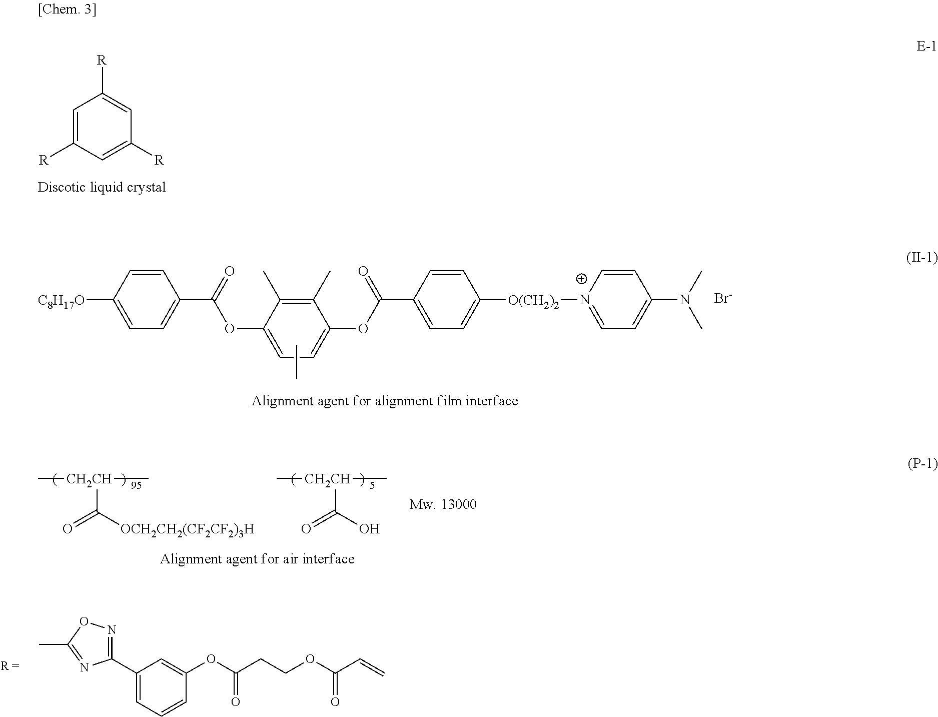

<Preparation of Antireflection Film>

(Preparation of Coating Liquid for Hard Coat Layer)

The following composition was put into a mixing tank and stirred, thereby preparing a coating liquid for a hard coat layer.

100 parts by mass of cyclohexanone, 750 parts by mass of polyfunctional acrylate partially modified with caprolactone (DPCA-20, manufactured by Nippon Kayaku Co., Ltd.), 200 parts by mass of silica sol (MIBK-ST, manufactured by NISSAN CHEMICAL INDUSTRIES, LTD.), and 50 parts by mass of photopolymerization initiator (Irgacure 184, manufactured by Ciba Specialty Chemicals, Inc.) were added to 900 parts by mass of methyl ethyl ketone. The resultant was stirred and then filtered through a filter made of polypropylene having a pore size of 0.4 μm, thereby preparing a coating liquid for a hard coat layer.

(Preparation of Coating Liquid A for Middle-Refractive Index Layer)

1.5 parts by mass of a mixture (DPHA) consisting of dipentaerythritol pentaacrylate and dipentaerythritol hexaacrylate, 0.05 parts by mass of a photopolymerization initiator (Irgacure 907, manufactured by Ciba Specialty Chemicals Inc.), 66.6 parts by mass of methyl ethyl ketone, 7.7 parts by mass of methyl isobutyl ketone, and 19.1 parts by mass of cyclohexanone were added to 5.1 parts by mass of a ZrO₂ particle-containing hard coat agent (Desolite Z7404 [refractive index 1.72, solid content concentration: 60% by mass, content of zirconium oxide particles: 70% by mass (amount with respect to solid content), average particle size of zirconium oxide particles: about 20 nm, makeup of solvent: methyl isobutyl ketone/methyl ethyl ketone=9/1, manufactured by JSR corporation]), followed by stirring. The resultant was thoroughly stirred and then filtered through a filter made of polypropylene having a pore size of 0.4 μm, thereby preparing a coating liquid A for a middle-refractive index layer.

(Preparation of Coating Liquid B for Middle-Refractive Index Layer)

4.5 parts by mass of a mixture (DPHA) consisting of dipentaerythritol pentaacrylate and dipentaerythritol hexaacrylate, 0.14 parts by mass of photopolymerization initiator (Irgacure 907, manufactured by Ciba Specialty Chemicals Inc.), 66.5 parts by mass of methyl ethyl ketone, 9.5 parts by mass of methyl isobutyl ketone, and 19.0 parts by mass of cyclohexanone were mixed together, followed by stirring. The resultant was thoroughly stirred and then filtered through a filter made of polypropylene having a pore size of 0.4 μm, thereby preparing a coating liquid B for a middle-refractive index layer.

The coating liquid A for a middle-refractive index layer and the coating liquid B for a middle-refractive index layer were mixed together in an appropriate amount such that a refractive index of 1.36 and a film thickness of 90 μm were obtained, thereby preparing a middle-refractive index coating liquid.

(Preparation of Coating Liquid for High-Refractive Index Layer)

0.75 parts by mass of a mixture (DPHA) consisting of dipentaerythritol pentaacrylate and dipentaerythritol hexaacrylate, 62.0 parts by mass of methyl ethyl ketone, 3.4 parts by mass of methyl isobutyl ketone, and 1.1 parts by mass of cyclohexanone were added to 14.4 parts by mass of a ZrO₂ particle-containing hard coat agent (Desolite Z7404 [refractive index 1.72, solid content concentration: 60% by mass, content of zirconium oxide particles: 70% by mass (amount with respect to solid content), average particle size of zirconium oxide particles: about 20 nm, containing a photopolymerization initiator, makeup of solvent: methyl isobutyl ketone/methyl ethyl ketone=9/1, manufactured by JSR corporation]), followed by stirring. The resultant was thoroughly stirred and then filtered through a filter made of polypropylene having a pore size of 0.4 μm, thereby preparing a coating liquid C for a high-refractive index layer.

(Preparation of Coating Liquid for Low-Refractive Index Layer)

(Synthesis of Perfluoroolefin Copolymer (1))

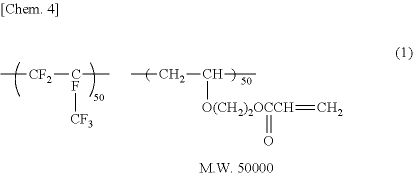

In the above structural formula, “50:50” represents a molar ratio.

40 ml of ethyl acetate, 14.7 g of hydroxyethyl vinyl ether, and 0.55 g of dilauroyl peroxide were put into an autoclave having an internal capacity of 100 ml equipped with a stirrer made of stainless steel, and the inside of the system was subjected to deaeration and nitrogen gas purging. Furthermore, 25 g of hexafluoropropylene (HFP) was put into the autoclave, and the temperature thereof was increased to 65° C. The pressure at the point in time when the internal temperature of the autoclave reached 65° C. was 0.53 MPa (5.4 kg/cm²). The reaction was continued for 8 hours at a temperature kept at 65° C., and at a point in time when the pressure reached 0.31 MPa (3.2 kg/cm²), heating was stopped, and the autoclave was left to cool. At a point in time when the internal temperature was reduced to room temperature, the unreacted monomer was discharged, and the reaction liquid was taken out by opening the autoclave. The obtained reaction liquid was poured into a large excess of hexane, and the solvent was removed by decantation, thereby taken out the precipitated polymer. The polymer was dissolved in a small amount of ethyl acetate and reprecipitated twice in hexane, thereby completely removing the residual monomer. After the resultant was dried, 28 g of a polymer was obtained. Then, 20 g of the polymer was dissolved in 100 ml of N,N-dimethyl acetamide, and 11.4 g of acrylic acid chloride was added dropwise thereto under ice cooling, and then the resultant was stirred for 10 hours at room temperature. Ethyl acetate was added to the reaction liquid, the resultant was washed with water, and the organic layer was extracted. Thereafter, the organic layer was concentrated, and the obtained polymer was reprecipitated in hexane, thereby obtaining 19 g of a perfluoroolefin copolymer (1). The obtained polymer had a refractive index of 1.422 and a mass average molecular weight of 50,000.

(Preparation of Hollow Silica Particle Dispersion A)

30 parts by mass of acryloyloxypropyl trimethoxysilane and 1.51 parts by mass of diisopropoxy aluminum ethyl acetate were added to and mixed with 500 parts by mass of hollow silica particle sol (isopropyl alcohol silica sol, CS60-IPA manufactured by Shokubai Kasei Industries, Ltd., average particle size of 60 nm, shell thickness of 10 nm, silica concentration of 20% by mass, refractive index of silica particles of 1.31), and then 9 parts by mass of deionized water was added thereto. The resultant was reacted for 8 hours at 60° C. and then left cool to room temperature, and 1.8 parts by mass of acetyl acetone was added thereto, thereby obtaining dispersion. Thereafter, while cyclohexanone was being added thereto such that the content of silica became substantially constant, solvent substitution was performed by distillation under reduced pressure of 30 Torr, and finally the concentration was adjusted, thereby obtaining a dispersion A having a solid content concentration of 18.2% by mass. The amount of residual IPA in the obtained dispersion A analyzed by gas chromatography was equal to or less than 0.5% by mass.

(Preparation of Coating Liquid for Low-Refractive Index Layer)

The respective components were mixed together as below and dissolved in methyl ethyl ketone, thereby preparing a coating liquid for a low-refractive index layer having a solid content concentration of 5% by mass. The “% by mass” of the each of the following components represents the ratio of solid content of each of the components to the total solid content of the coating liquid.

P-1: the aforementioned perfluoroolefin copolymer (1): 15% by mass

DPHA: mixture consisting of dipentaerythritol pentaacrylate and dipentaerythritol hexaacrylate (manufactured by Nippon Kayaku Co., Ltd.): 7% by mass

MF1: the following fluorine-containing unsaturated compound (weight-average molecular weight of 1,600) described in Example of WO 2003/022906): 5% by mass

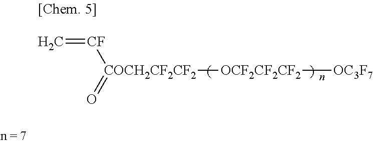

M-1: Kayarad DPHA manufactured by Nippon Kayaku Co., Ltd.: 20% by mass

Dispersion A: the aforementioned hollow silica particle dispersion A (hollow silica particle sol having surface modified with acryloyloxypropyl trimethoxysilane, solid content concentration of 18.2%): 50% by mass

Irg 127: photopolymerization initiator Irgacure 127 (manufactured by Ciba Specialty Chemicals Inc.): 3% by mass

The surface, which is at the side opposite to the phase difference layer of the transparent support, of the optical film prepared as above was coated with the coating liquid for a hard coat layer having the aforementioned makeup by using a gravure coater. After the film was dried at 100° C., in a state in which nitrogen purging was performed to produce an atmosphere having an oxygen concentration of equal to or less than 1.0% by volume, the coating layer was cured by being irradiated with ultraviolet rays having an illuminance of 400 mW/cm² in an irradiation amount of 150 mJ/cm² by using an air-cooled metal halide lamp (manufactured by EYE GRAPHICS Co., Ltd.) of 160 W/cm, thereby forming a hard coat layer A having a thickness of 12 μm.

Thereafter, the film was further coated with the coating liquid for a middle-refractive index layer, the coating liquid for a high-refractive index layer, and the coating liquid for a low-refractive index layer by using a gravure coater. The middle-refractive index layer was dried for 30 seconds at 90° C., and in a state in which nitrogen purging was performed to produce an atmosphere having an oxygen concentration of equal to or less than 1.0% by volume, the middle-refractive index layer was cured by being irradiated with ultraviolet rays having an illuminance of 300 mW/cm² in an irradiation amount of 240 mJ/cm² by using an air-cooled metal halide lamp (manufactured by EYE GRAPHICS Co., Ltd.) of 180 W/cm.

The high-refractive index layer was dried for 30 seconds at 90° C., and in a state in which nitrogen purging was performed to produce an atmosphere having an oxygen concentration of equal to or less than 1.0% by volume, the high-refractive index layer was cured by being irradiated with ultraviolet rays having an illuminance of 300 mW/cm² in an irradiation amount of 240 mJ/cm² by using an air-cooled metal halide lamp (manufactured by EYE GRAPHICS Co., Ltd.) of 240 W/cm.

The low-refractive index layer was dried for 30 seconds at 90° C., and in a state in which nitrogen purging was performed to produce an atmosphere having an oxygen concentration of equal to or less than 0.1% by volume, the low-refractive index layer was cured by being irradiated with ultraviolet rays having an illuminance of 600 mW/cm² in an irradiation amount of 600 mJ/cm² by using an air-cooled metal halide lamp (manufactured by EYE GRAPHICS Co., Ltd.) of 240 W/cm.

|Rth (550)| and |ΔRth (30% RH-80% RH)| of the optical film prepared as above, that is, |Rth (550)| and |ΔRth (30% RH-80% RH)| of the laminated portion consisting essentially of the transparent support, the alignment film, the optically anisotropic layer, and the antireflection layer were measured by the aforementioned methods. The results are shown in the following Table 1. In the following description, the laminated portion consisting essentially of the transparent support, the alignment film, the optically anisotropic layer, and the antireflection layer is simply abbreviated to a “laminated portion (optical film)”.

<Preparation of Release Film>

Polyethylene terephthalate was melted, extruded from a cap, and cooled and solidified in a casting drum at 25° C. Thereafter, the film was heated by a roll heated to 85° C. and a radiation heater and stretched such that the film was stretched 2.8-fold in the longitudinal direction and then stretched 3.53-fold at 110° C. in the width direction by using a tenter. The film was then subjected to thermal processing at 200° C. in a thermal processing zone following the tenter, thereby obtaining a polyester film having a thickness of 38.2 μm. The rupture strength, the rupture elongation, and the elastic modulus of the obtained film were 189 MPa, 200%, and 3.9 GPa, respectively, in the longitudinal direction and were 260 MPa, 105%, and 5.5 GPa, respectively, in the width direction.

<Formation of Release Film with Adhesive Layer>

(Preparation of Monomer Emulsion)

900 parts of butyl acrylate, 50 parts of acrylic acid, and 50 parts of N,N-dimethyl acrylamide were put into a container and mixed together, thereby preparing a monomer mixture. Thereafter, 18 parts of Aqualon HS-10 (manufactured by DAI-ICHI KOGYO SEIYAKU CO., LTD.) as a reactive surfactant and 382 parts of deionized water were added to 600 parts of the prepared monomer mixture consisting of the components at the aforementioned ratio, and the resultant was subjected to forcible emulsification by being stirred with a homomixer (manufactured by TOKUSHUKIKA KOGYO CO., LTD.) for 5 minutes at 6,000 (rpm), thereby preparing a monomer emulsion.

(Preparation of Aqueous Dispersion)

200 parts of the monomer emulsion prepared as above and 330 parts of deionized water were put into a reaction container equipped with a cooling tube, a nitrogen introduction tube, a thermometer, a dropping funnel, and a stirring blade. Subsequently, the reaction container was thoroughly purged with nitrogen, 0.6 parts of ammonium persulfate was then added thereto, and the resultant was polymerized for 1 hour at 60° C. while being stirred. Then, 800 parts of the remaining monomer emulsion was added dropwise over 3 hours to the reaction container kept at 60° C., followed by polymerization for 3 hours, thereby obtaining an aqueous dispersion containing emulsion particles of a (meth)acryl-based copolymer with a solid content concentration of 46%. Thereafter, the aqueous dispersion was cooled to room temperature, and then, aqueous ammonia having a concentration of 10% was added thereto such that the pH thereof became 8, thereby obtaining an aqueous dispersion having a solid content adjusted to 46%.

(Preparation of Aqueous Dispersion-Type Adhesive Composition)

100 parts (expressed in terms of the solid content) of an aqueous dispersion (solid content concentration of 46%) containing the (meth)acryl-based polymer obtained by the aforementioned preparation example was mixed with 0.03 parts of 3-glycidoxypropyl trimethoxysilane (manufactured by Shin-Etsu Chemical Co., Ltd., KBM-403) as a silane coupling agent and 1.25 parts (0.5 parts when expressed in terms of the solid content) of a carbodiimide-based compound (manufactured by Nisshinbo Holdings Inc., Carbodilite V-04, solid content of 40%) as a crosslinking agent, thereby obtaining a aqueous dispersion-type adhesive composition.

The aforementioned release film was coated with the aqueous dispersion-type adhesive composition by using a die coater such that the thickness of the adhesive composition after drying became 20 μm, and then, the film was dried for 2 minutes at 120° C., thereby forming an adhesive layer. By sticking the adhesive layer on the side opposite to the hard coat layer, the adhesive layer and the release film were stuck on the optical film.

<Formation of Surface Protection Film>

(Preparation of Adhesive Composition)

100 parts by weight of 2-ethylhexyl acrylate and 4 parts by weight of acrylic acid were copolymerized in ethyl acetate by a common method, thereby obtaining an acryl-based polymer solution having a weight-average molecular weight of 600,000 (expressed in terms of polystyrene). 4 parts by weight of an epoxy-based crosslinking agent (manufactured by MITSUIBISHI GAS CHEMICAL COMPANY, INC., “Tetrad C”) was added to 100 parts by weight (non-volatile content) of the acryl-based polymer solution, and then, the resultant was diluted with ethyl acetate, thereby obtaining an acryl-based adhesive having a non-volatile content of 20% by mass.

(Preparation of Surface Protection Film)

A biaxially oriented polyester film (manufactured by KOLON INDUSTRIES, INC., “FQ00 #25”, thickness of 25 μm) as a substrate film was coated with the acryl-based adhesive such that the thickness of the adhesive after drying (130° C.×1 min) became 30 μm, thereby obtaining a surface protection film.

Thereafter, the adhesive layer was stuck on the side of the hard coat layer, thereby obtaining an optical laminate in which the surface protection film was formed.

### Example 2

A transparent cellulose acetate support was prepared in the same manner as in Example 1, except that the thickness thereof was changed to 20 μm. By using the support, an optical laminate was prepared in the same manner as in Example 1.

### Example 3

A transparent cellulose acetate support was prepared in the same manner as in Example 1, except that the thickness thereof was changed to 25 μm. By using the support, an optical laminate was prepared in the same manner as in Example 1.

### Example 4

A transparent cellulose acetate support was prepared in the same manner as in Example 1, except that the thickness thereof was changed to 30 μm. By using the support, an optical laminate was prepared in the same manner as in Example 1.

### Example 5

### Preparation of Transparent Support

A dope having the following makeup was prepared.

Makeup of Dope:

| | | |
|---|---|---|
| Cellulose acetate (degree of acetyl substitution of | 100 | parts by mass |
| 2.86, number-average molecular weight of 88,000) | | |
| Triphenyl phosphate | 9.8 | parts by mass |
| Compound 1 of the following formula | 2.9 | parts by mass |
| Compound 2 of the following formula | 0.3 | parts by mass |
| Compound 3 of the following formula | 1.0 | part by mass |
| Silica particles having an average particle size | 0.14 | parts by mass |
| of 16 nm (aerosol R972, manufactured by Nippon | | |
| Aerosil Co.) | | |
| Dichloromethane | 424.5 | parts by mass |
| Methanol | 63.4 | parts by mass |

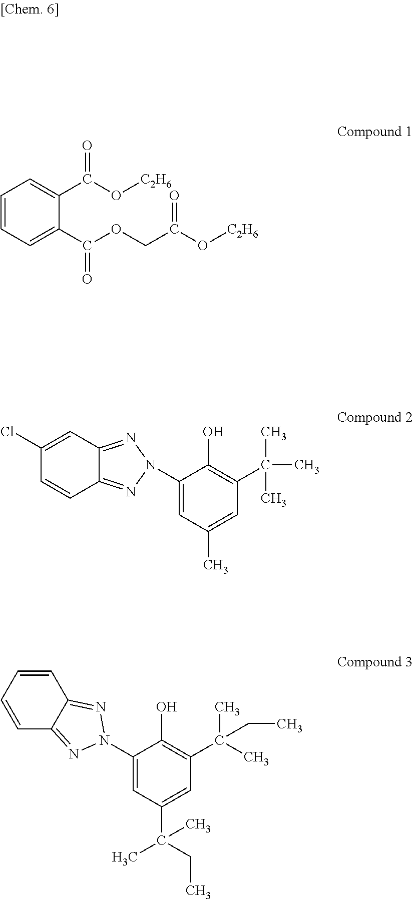

The dope liquid having the aforementioned makeup was uniformly casted onto a stainless steel band support by using a band casting apparatus. The solvent was evaporated until the amount of the residual solvent became 40% by mass on the stainless steel band support, and the film was peeled from the stainless steel band support. After the film was peeled, in a state in which both ends thereof were gripped by a tenter, the film was transported while being stretched in the width direction such that the film was stretched 1.04-fold (4%) in the width direction.

After being stretched, the film was dried for 35 minutes in a drying zone at 115° C. while being transported. After being dried, the film was slit in a width of 1,980 mm, thereby preparing a transparent support having a thickness of 30 μm.

<Formation of Optically Anisotropic Layer>

Thereafter, according to the method described in Example of JP 2012-517024 A, an optically anisotropic layer having first and second phase difference regions was formed by using LC242 manufactured by BASF Corporation as a rod-like liquid crystal (RLC).

An optical laminate was prepared in the same manner as in Example 1, except that the aforementioned transparent support and optically anisotropic layer were used.

### Example 6

An optical laminate was prepared in the same manner as in Example 1, except that the following transparent support was used.

<Preparation of Transparent Support>

(1) Preparation of Dope for Core Layer

A dope for a core layer having the following makeup was prepared.

Makeup of dope for core layer

| | | |
|---|---|---|
| Cellulose acetate (degree of acetylation of 2.86, | 100 | parts by mass |
| number-average molecular weight of 72,000) | | |
| Methylene chloride (first solvent) | 320 | parts by mass |
| Methanol (second solvent) | 83 | parts by mass |
| 1-Butanol (third solvent) | 3 | parts by mass |
| Triphenyl phosphate | 7.2 | parts by mass |
| Biphenyl diphenyl phosphate | 3.6 | parts by mass |
| The following compound 1 | 0.98 | parts by mass |
| The following compound 2 | 0.24 | parts by mass |

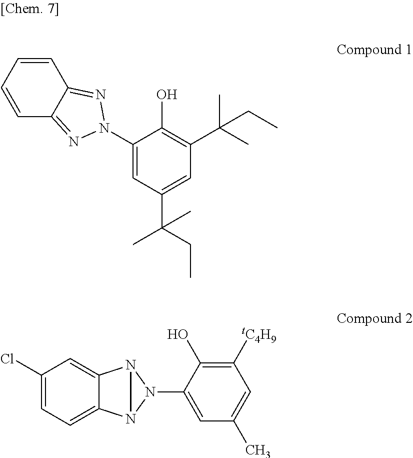

Specifically, the dope was prepared by the following method. The first solvent, the second solvent, and the third solvent were put into a 4,000 L dissolution tank made of stainless steel having a stirring blade and thoroughly stirred. Thereafter, cellulose acetate powder (flake), triphenyl phosphate, biphenyl diphenyl phosphate, the compound 1, and the compound 2 were slowly added thereto, thereby preparing a mixture having an amount of 2,000 kg in total. Herein, all of the solvents used had a moisture content of equal to or less than 0.5% by mass.

The mixture in the dissolution tank was dispersed for 30 minutes by using two stirring shafts. Specifically, as the two stirring shafts, a dissolver type eccentric stirring shaft, which stirred the mixture at a circumferential speed of 5 m/sec (shear stress: 5×10⁴ kgf/m/sec²) as a stirring shear speed, and a stirring shaft, which had an anchor blade as a central shaft and stirred the mixture at a circumferential speed of 1 m/sec (shear stress: 1×10⁴ kgf/m/sec²), were used. The dispersion was started at a temperature of 25° C., and the temperature finally reached 48° C. After the dispersion ended, the high-speed stirring was stopped, and the circumferential speed of the anchor blade was controlled to be 0.5 m/sec. In this state, the mixture was further stirred for 100 minutes such that the cellulose acetate powder was swelled. Until the swelling ended, the internal pressure of the tank was increased to 0.12 MPa by using nitrogen gas. At this time, the oxygen concentration in the tank was kept to be less than 2 vol % so as to prevent a problem of explosion. Furthermore, it was confirmed that the amount of water contained in the dope was equal to or less than 0.5% by mass. Specifically, the amount of water was 0.3% by mass.

The solution containing the swollen cellulose acetate powder was sent to a jacketed piping from the dissolution tank by a pump. Then the solution was heated to 50° C. in the jacketed piping and then further heated to 90° C. under a pressure increased to 2 MPa, whereby the swollen cellulose acetate powder was completely dissolved. The heating time was 15 minutes.

Thereafter, the temperature of the solution was decreased to 36° C., and the solution was filtered through a filter medium having a nominal pore size of 8 μm, thereby obtaining a dope. At this time, the primary filtering pressure was 1.5 MPa, and the secondary filtering pressure was 1.2 MPa. As the filter, housing, and piping exposed to a high temperature, those made of a hastelloy alloy, having excellent corrosion resistance, and including a jacket through which a heat medium for heat retaining and heating flowed were used.

The dope, which was obtained as above and had not yet been concentrated, was flashed in a flash apparatus adjusted to 80° C. and a normal pressure, and the solvent evaporated in this manner was recovered and separated by using a condenser. The solid content concentration of the flashed dope was 21.8% by mass. Moreover, the condensed solvent was sent to the recovery process such that it was reused as a solvent of the preparation process. As a flash tank of the flash apparatus, a tank of which a central shaft had an anchor blade was used, and the dope was defoamed by being stirred at a circumferential speed of 0.5 m/sec. The temperature of the dope in the tank was 25° C., and an average residence time thereof in the tank was 50 minutes. As a result of collecting the dope and measuring a shear viscosity thereof at 25° C., it was confirmed that the shear viscosity was 450 (Pa·s) at a shear speed of 10 (sec⁻¹).

Then, the dope was irradiated with weak ultrasonic waves, thereby removing bubbles thereof. Subsequently, in a state in which the pressure thereof was increased to 1.5 MPa, the dope was initially filtered through a sintered fiber metal filter having a nominal pore size of 10 μm and then filtered through a sintered fiber filter having a pore size of 10 μm. The primary pressures were 1.5 MPa and 1.2 MPa, respectively, and the secondary pressures were 1.0 MPa and 0.8 MPa, respectively. The temperature of the filtered dope was adjusted to be 36° C., and then, the dope was stored in a 2,000 L stock tank made of stainless steel. As the stock tank, a tank of which a central shaft had an anchor blade was used, and the dope was constantly stirred at a circumferential speed of 0.3 m/sec, thereby obtaining a dope 1 for a core layer.

(2) Preparation of Dope 1-a for Support Layer

A matting agent (silicon dioxide (particle size of 20 nm)), a release accelerating agent (citric acid ethyl ester (mixture of citric acid, monoethyl ester, diethyl ester, and triethyl ester)), and the dope 1 for a core layer were mixed together through a static type mixer, thereby preparing a dope 1-a for a support layer. The dope 1, the matting agent, and the release accelerating agent were mixed together such that the solid content concentration became 20.5% by mass in total, the concentration of the matting agent became 0.05% by mass, and the concentration of the release accelerating agent became 0.03% by mass.

(3) Preparation of Dope 1-b for Air Layer

A matting agent (silicon dioxide (particle size of 20 nm)) was mixed with the dope 1 for a core layer through a static type mixer, thereby preparing a dope 1-b for an air layer. The matting agent and the dope 1 were mixed together such that the solid content concentration became 20.5% by mass in total, and the concentration of the matting agent became 0.1% by mass.

(4) Forming Film by Co-Casting

As a casting die, an apparatus was used which was equipped with a feed block adjusted for co-casting and could form a film having a three-layer structure in which a layer was laminated on each of both surfaces of a main flow. In the following description, the layer formed from the main flow will be called a core layer, the layer at the side of the support surface will be called a support layer, and the layer at the opposite side will be called an air layer. As flow channels for the dopes, three flow channels for the core layer, the support layer, and the air layer were used.

From a casting outlet, the dope for a core layer, the dope 1-a for a support layer, and the dope 1-b for an air layer were co-casted onto a drum cooled to −5° C. At this time, the flow rate of each of the dopes was adjusted such that a thickness ratio became air layer/core layer/support layer=3/35/3. The dope film formed by casting was dried by being exposed to dry air at 34° C. at a rate of 230 m³/min and peeled from the drum in a state of containing 150% of residual solvent. At the time of peeling, the film was stretched 17% in the transport direction (longitudinal direction). Thereafter, the film was transported in a state in which both ends thereof in the width direction (direction orthogonal to the casting direction) were gripped by a pin tenter (pin tenter shown in FIG. 3 of JP 4-1009 A). Then, the film was further dried by being transported between rolls of a thermal processing apparatus, thereby manufacturing a transparent support. The amount of the residual solvent in the prepared transparent cellulose acylate support was 0.2%, and the thickness thereof was 40

### Example 7

An optical laminate was prepared in the same manner as in Example 5, except that the following transparent support was used.

<Preparation of Transparent Support>

A dope having the following makeup was prepared.

Makeup of Dope:

| | | |
|---|---|---|
| Cellulose acetate (degree of acetyl substitution of | 100 | parts by mass |
| 2.86, number-average molecular weight of 88,000) | | |
| Compound 1 of the following formula | 3.2 | part by mass |
| Compound 2 of the following formula | 0.5 | parts by mass |
| Compound 3 of the following formula | 1.5 | parts by mass |
| Compound 4 of the following formula | 2.1 | parts by mass |
| Compound 5 of the following formula | 1.3 | parts by mass |
| Compound 6 of the following formula | 0.5 | parts by mass |
| Compound 7 of the following formula | 0.6 | parts by mass |
| Silica particles having an average particle size of | 0.14 | parts by mass |
| 16 nm (aerosol R972, manufactured by Nippon | | |
| Aerosil Co.) | | |
| Dichloromethane | 424.5 | parts by mass |
| Methanol | 63.4 | parts by mass |

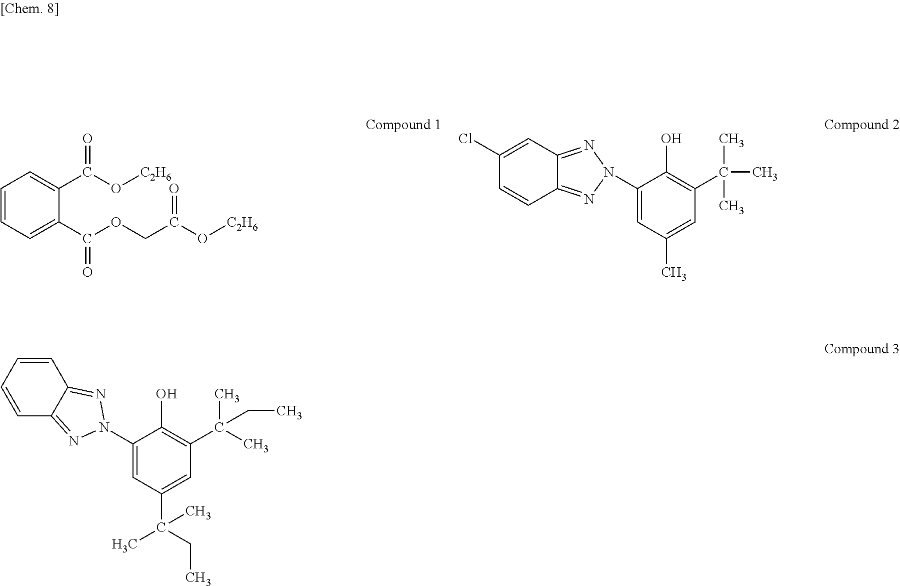

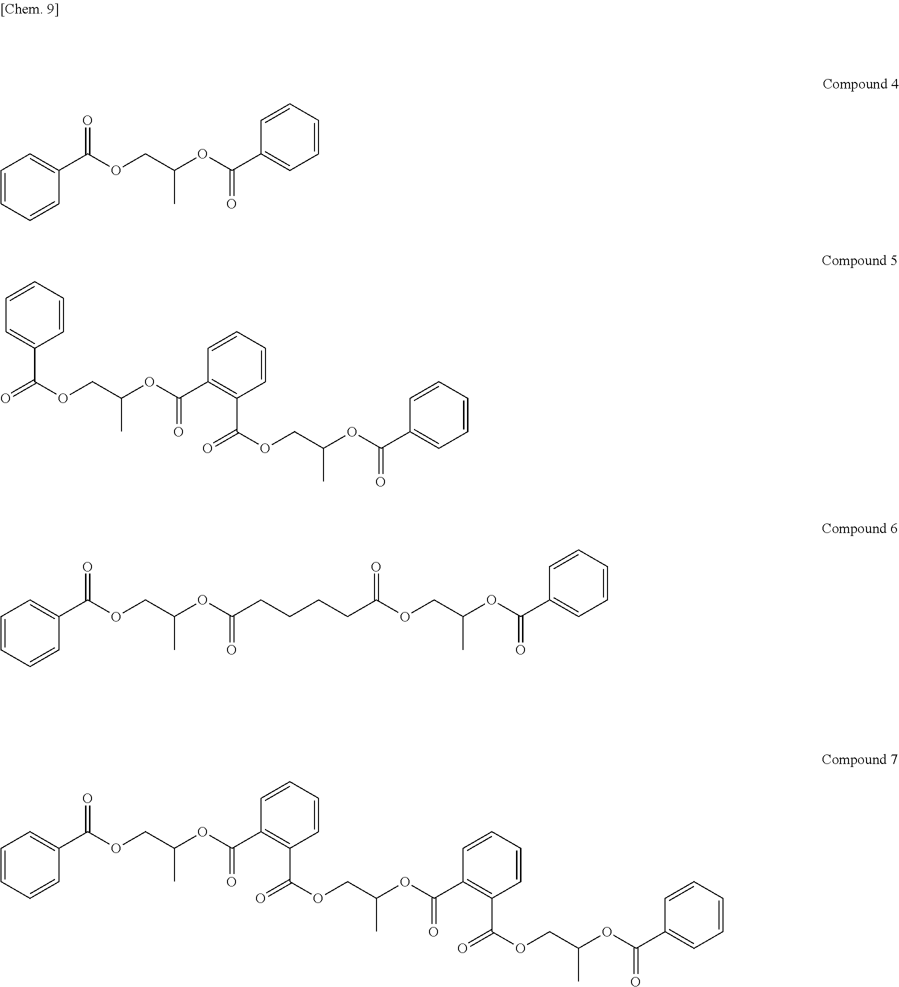 [SMILES: CC(COC(=O)c1ccccc1)OC(=O)c1ccccc1 ; CC(COC(=O)c1ccccc1C(=O)OC(C)COC(=O)c1ccccc1)OC(=O)c1ccccc1 ; CC(COC(=O)c1ccccc1)OC(=O)CCCCC(=O)OCC(C)OC(=O)c1ccccc1 ; CC(COC(=O)c1ccccc1C(=O)OC(C)COC(=O)c1ccccc1C(=O)OC(C)COC(=O)c1ccccc1)OC(=O)c1ccccc1]

The dope liquid having the aforementioned makeup was uniformly casted onto a stainless steel band support by using a band casting apparatus. The solvent contained in the casted film was evaporated until the amount of the residual solvent became 40% by mass on the stainless steel band support, and the film was peeled from the stainless steel band support. After the film was peeled, in a state in which both ends thereof were gripped by a tenter, the film was transported while being stretched in the width direction such that the film was stretched 1.04-fold (4%) in the width direction.

After being stretched, the film was dried for 35 minutes in a drying zone at 115° C. while being transported. After being dried, the film was slit in a width of 1,980 mm, thereby preparing a transparent support having a thickness of 40 μm.

### Example 8

An optical laminate was prepared in the same manner as in Example 5, except that the following transparent support was used.

<Preparation of Transparent (Meth)Acryl-Based Resin Support>

Pellets of a mixture (Tg of 127° C.), which consisted of 90 parts by weight of a (meth)acryl-based resin having a lactone ring structure {weight ratio between copolymerized monomers=methyl methacrylate/methyl 2-(hydroxymethyl) acrylate=8/2, rate of lactone cyclization of about 100%, content of lactone ring structure of 19.45, weight-average molecular weight of 133,000, melt flow rate of 6.5 g/10 min (240° C., 10 kgf), Tg of 131° C.} represented by the following Formula (1) (in the formula, R¹ represents a hydrogen atom, and each of R² and R³ represents a methyl group) and 10 parts by weight of an acrylonitrile-styrene (AS) resin {Toyo AS AS20, manufactured by TOYO STYRENE CO., LTD.}, were supplied into a biaxial extruder and melt-extruded in the form of a sheet at a temperature of about 280° C., thereby obtaining a (meth)acryl-based resin sheet having a lactone ring structure and a thickness of 110 μm. The unstretched sheet was vertically stretched 2.0-fold and horizontally stretched 2.4-fold under a temperature condition of 160° C., thereby obtaining a transparent (meth)acryl-based resin support (thickness: 40 μm).

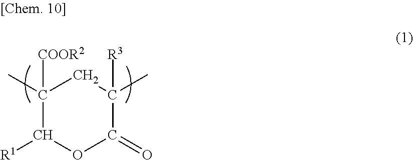

(Corona Discharge Processing)

One side of the obtained transparent (meth)acryl-based resin support was subjected to corona discharge processing (irradiation amount of electron for corona discharge: 77 W/m²/min).

(Formation of Easily Adhesive Layer)

16.8 g of polyester urethane (manufactured by DAI-ICHI KOGYO SEIYAKU CO., LTD., trade name: Superflex 210, solid content: 33%), 4.2 g of a crosslinking agent (oxazoline-containing polymer, manufactured by NIPPON SHOKUBAI CO., LTD., trade name: Epocros WS-700, solid content: 25%), 2.0 g of 1% by mass aqueous ammonia, 0.42 g of colloidal silica (manufactured by FUSO CHEMICAL CO., LTD., Quattron PL-3, solid content: 20% by mass), and 76.6 g of pure water were mixed together, thereby obtaining an easily adhesive composition.

The corona discharge-processed surface of the transparent (meth)acryl-based resin support having undergone the corona discharge processing was coated with the obtained easily adhesive composition by using a bar coater (#6) such that the thickness after drying became 350 nm. The transparent (meth)acryl-based resin support was then put into a hot air drier (140° C.), and the easily adhesive composition was dried for about 5 minutes, thereby forming an easily adhesive layer (0.3 μm to 0.5 μl).

### Example 9

An optical laminate was prepared in the same manner as in Example 5, except that the following transparent support was used.

<Preparation of Transparent Norbornene-Based Resin Support>

By using Arton R5300 (manufactured by JSR Corporation, thickness: 40 μm) and a corona surface processing apparatus (“AGF-012” manufactured by KASUGA ELECTRIC WORKS LTD.), corona discharge processing was performed on the film surface at a discharge amount of 320 W·min/m². After the corona surface processing, the film was coated with the following radiationcurable composition for an adhesive by using a #3 wire bar coater, and the composition was irradiated with light from a metal halide lamp (illuminance of 276 mW/cm², light irradiation amount of 663 mJ/cm²).

(Radiation Curable Composition for Adhesive)

Components (A) to (E) and optional components at the following mixing ratio were put into a container with a stirring apparatus and evenly mixed together by being stirring for 4 hours. After the stirring was stopped, the mixture was left to stand for 24 hours.

Component (A):

| | |
|---|---|
| Celloxide 2021P: 3,4-epoxycyclohexenylmethyl- | 33.4 parts by weight |
| 3′,4′-epoxycyclohexene carboxylate (manufactured | |
| by Daicel Corporation) | |

Component (B):

| | |
|---|---|
| C-2090: poly((3-methyl-1,5-pentanediol; 1,6- | 6.3 parts by weight |
| hexanediol)carbonate) (manufactured by | |
| KURARAY CO., LTD.; number-average molecular | |
| weight of 2,000) | |
| Sannix GP-400: polyoxypropylene glyceryl ether | 11.5 parts by weight |
| (manufactured by Sanyo Chemical Industries, Ltd.; | |
| number-average molecular weight of 420) | |

Component (C)

| | |
|---|---|
| Propylene glycol monomethyl ether: manufactured by | 9.6 parts by weight |
| Nippon Nyukazai Co., Ltd.; trade name: methyl | |
| propylene glycol (MFG) | |

Component (D)

| | |
|---|---|
| Diphenyl[4-(phenylthio)phenyl]sulfonium | 4.6 parts by weight |
| hexafluorophosphate (manufactured by San-Apro Ltd.) | |

Component (E):

| | |
|---|---|
| Neopentyl glycol diglycidyl ether (manufactured by | 34.6 parts by weight |
| Sakamoto Yakuhin Kogyo Co., Ltd.) | |

### Example 10

A transparent cellulose acetate support was prepared in the same manner as in Example 5, except that the thickness of the support was changed to 50 μm.

An optical laminate was prepared in the same manner as in Example 5, except that the above transparent support was used.

### Example 11

An optical laminate was prepared in the same manner as in Example 5, except that the following transparent support was used

<Preparation of Transparent Cellulose Acylate Support>

(1) Preparation of Dope

<1-1> Cellulose Acylate Solution

The following composition was put into a mixing tank and stirred such that the respective components were dissolved. Thereafter, the resultant was heated for about 10 minutes at 90° C. and then filtered through a filter paper having an average pore size of 34 μm and a sintered metal filter having an average pore size of 10 μm.

(Cellulose Acylate Solution)

| | |
|---|---|
| Cellulose acylate (degree of acyl substitution: 2.82, | 100.0 parts by mass |
| degree of acetyl substitution: 2.82) | |
| Dichloromethane | 403.0 parts by mass |
| Methanol | 60.2 parts by mass |

<1-2> Matting Agent Dispersion

Subsequently, the following composition containing the cellulose acylate solution prepared as above was put into a disperser, thereby preparing a matting agent dispersion.

(Matting Agent Dispersion)

| | | |
|---|---|---|
| Silica particles having an average particle size of | 2.0 | parts by mass |
| 16 nm (aerosil R972 manufactured by Nippon | | |
| Aerosil Co.) | | |
| Dichloromethane | 72.4 | parts by mass |
| Methanol | 10.8 | parts by mass |
| Aforementioned cellulose acylate solution | 10.3 | part by mass |

<1-3> Additive Solution

The cellulose acylate solution prepared as above was put into a mixing tank and dissolved by being stirred under heating, and 9 parts by mass of an additive (PB-33) and 4 parts by mass of an additive (U) were added thereto, thereby preparing an additive solution. Each of the additives will be described below. Herein, the amount of each of the additives added was an amount with respect to 100 parts by mass of cellulose acylate.

PB-33: condensate (number-average molecular weight of 800) consisting of adipic acid/phthalic acid/terephthalic acid/ethylene glycol (10/1/9/20 (molar ratio)) in which both terminals have become acetyl ester Compound U:

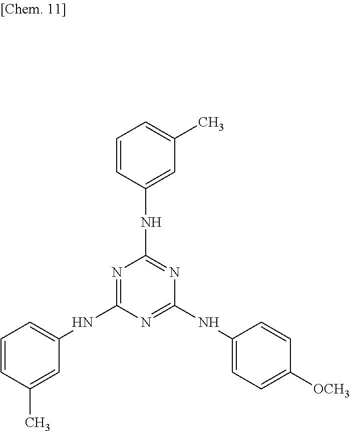 [SMILES: COc1ccc(Nc2nc(Nc3cccc(C)c3)nc(Nc3cccc(C)c3)n2)cc1]

100 parts by mass of the cellulose acylate solution, 1.35 parts by mass of the matting agent dispersion, and the additive solution were mixed together, thereby preparing a dope for forming a film.

The cellulose acylate and the respective additives used as raw materials of the dope were used after being dried for 2 hours at 120° C. by using a silo manufactured by NARA MACHINERY CO., LTD.

(2) Casting Process

Thereafter, the dope in the stock tank was sent by a gear pump for primary pressure boosting such that the pressure of the primary side of the high-accuracy gear pump became 0.8 MPa under feedback control by an inverter motor. The high-accuracy gear pump had a volumetric efficiency of 99.3% and a fluctuation rate of a discharge amount of equal to or less than 0.4%. Moreover, the discharge pressure thereof was 1.4 MPa.

As a casting die, an apparatus was used which was equipped with a feed block having a width of 1.6 m and adjusted for co-casting and could form a film having a three-layer structure in which a layer was laminated on each of both surfaces of a main flow. In the following description, the layer formed from the main flow will be called an intermediate layer, the layer at the side of the support surface will be called a support surface, and the layer at the opposite side will be called an air surface. As flow channels for the dope, three flow channels for the intermediate layer, the support surface, and the air surface were used. Herein, for manufacturing the present film, only the flow channel for the intermediate layer was used.

Thereafter, casting was performed while adjusting the flow rate of the polymer dope at the discharge opening of the die such that the film thickness of the completed transparent cellulose acylate support became 40 μm. In order to adjust the temperature of the dope to be 36° C., a jacket was provided in the casting die, and the temperature of the inlet of the heating medium supplied into the jacket was controlled to be 36° C.

All of the die, the feed block, and the piping were kept at 36° C. during the casting process. As the die, a coat hanger-type die was used in which thickness-adjusting bolts were arranged at a pitch of 20 mm and which was equipped with an automatic thickness-adjusting mechanism including heat bolts. By a preset program, the heat bolts can set a profile according to the amount of the dope sent by the high-accuracy gear pump. Furthermore, by an adjustment program based on a profile of an infrared thickness gauge installed in the film forming process, the heat bolts can be feedback controlled. The thickness of the film was adjusted, such that in the film excluding a casting edge portion having a length of 20 mm, a difference in thickness between any two points separated from each other by 50 mm was within 1 μm, and the maximum difference in the minimum thickness in the width direction become equal to or less than 2 μm/m. Moreover, a chamber for reducing pressure was installed at the primary side of the die. The degree of pressure reduction of the pressure reducing chamber was set such that a pressure difference of 1 Pa to 5,000 Pa could be applied to the front and back of casting bead, and can be adjusted according to the casting speed. At this time, the pressure difference was set such that the length of the bead became 2 mm to 50 mm.

(Casting Die)

For the die, a material was used which was two-phase based stainless steel composed of a mixture of an austenite phase and a ferrite phase, had a coefficient of thermal expansion of equal to or less than 2×10⁻⁵(° C.⁻¹), and exhibited substantially the same degree of corrosion resistance as SUS316 in a forced corrosion test in an aqueous electrolyte solution. The finishing accuracy of the wetted surface of the casting die and the feed block was equal to or less than 1 μm in terms of surface roughness, and straightness thereof was equal to or less than 1 μm/m in any direction. Moreover, the clearance of the slit could be adjusted to be 0.5 mm to 3.5 mm by automatic adjustment. For manufacturing the present film, the clearance was adjusted to be 1.5 mm. With respect to the corner of the wetted portion of the tip of the die lip, R was processed so as to be equal to or less than 50 μm over the total width of the slit. The shear speed was within a range of 1 (sec⁻¹) to 5,000 (sec⁻¹) inside the die.

As the casting die, a casting die provided with a hardened coating at the tip of the lip thereof was used. Materials of the hardened coating include tungsten/carbide (WC), Al₂O₃, TIN, Cr₂O₃, and the like, and among these, WC is particularly preferable. In the present invention, as the hardened coating, a WC coating formed by a thermal spraying method was used. Moreover, a mixed solvent (dichloromethane/methanol/butanol (83/15/2 parts by mass)) as a solvent for solubilizing the dope was supplied at a rate of 0.5 ml/min to a gas-liquid interface between the end of the bead and the slit from one side. Furthermore, in order to make the temperature of the pressure reducing chamber remain constant, a jacket was mounted thereon, and a heating medium adjusted to be 35° C. was supplied thereto. As an apparatus for controlling an air volume used in edge suction, an apparatus capable of adjusting an air volume within a range of 1 L/min to 100 L/min. For manufacturing the present film, the air volume of edge suction was appropriately adjusted within a range of 30 L/min to 40 L/min.

(Metal Support)

As a support, an endless band made of stainless steel having a length of 100 m was used. The band had a thickness of 1.5 mm, polished to have a surface roughness of equal to or less than 0.05 μm, made of SUS316, and had sufficient corrosion resistance and strength. The thickness unevenness of the entire band was equal to or less than 0.5%. As the band, a type that driven by two drums was used, and at this time, the tension of the band was adjusted to be 1.5×10⁴ kg/m, and a difference in relative speed between the band and the drum was equal to or less than 0.01 m/min. Furthermore, the fluctuation in driving speed of the band was equal to or less than 0.5%. In addition, the positions of both ends of the band were detected, thereby controlling the band such that meandering thereof in the width direction per revolution was restricted to be equal to or less than 1.5 mm. Moreover, the positional fluctuation of the support surface immediately below the casting die that occurs in the vertical direction due to the rotation of the drum was controlled to be equal to or less than 200 μm. The support was installed in a casing having means for inhibiting wind pressure vibration. The dope was casted onto the support from the die. The surface temperature of the central portion of the support measured immediately before the casting was 15° C., and a temperature difference between both ends thereof was equal to or less than 6° C. Because the metal support should not have surface defect, a support was used which did not have a pin hole equal to or greater than 30 μm, had pin hols of 10 μm to 30 μm in a number of equal to or less than one/m², and had pin holes of equal to or smaller than 10 μm in a number of two/m².

(Casting and Drying)

The temperature of a casting chamber provided with the casting die, the support, and the like was kept at 35° C. Initially, the dope casted onto the band was dried by being exposed to dry air of parallel flow. A coefficient of overall heat transfer to the dope from the dry air at the time of drying was 24 kcal/m²·hr·° C. The temperature of the dry air was 130° C. at the upstream side of the upper portion of the band and 135° C. at the downstream side thereof. The temperature of the dry air was 65° C. in the lower portion of the band. The saturation temperature of all of gases was around −8° C. The oxygen concentration in the dry atmosphere on the support was kept at 5 vol, and in order to keep the oxygen concentration at 5 vol %, air was purged by nitrogen gas. Moreover, in order to condense and recover the solvent in the casting chamber, a condenser was provided, and the temperature of the outlet thereof was set to be −10° C.

For 5 seconds after casting, the dope was protected from being directly exposed to the dry air by using a wind shielding apparatus, and the fluctuation in static pressure of regions very close to the casting die was controlled to be equal to or less than ±1 Pa. At a point in time when the proportion of the solvent in the dope became 45% by mass based on dry basis, the dope in the form of a film was peeled from the casting support. At this time, a peeling tension was set to be 8 kgf/m such that the film was appropriately stripped at a stripping speed (strip roll draw) within a range of 100.1% to 110% with respect to the support speed. The surface temperature of the stripped film was 14° C. The drying speed of the film on the support was 62% by mass (amount of solvent on dry basis)/min on average. The solvent gas generated by drying was guided to a condensing apparatus, liquefied at −10° C. and recovered, and reused as a solvent for preparing the dope. The dry air from which the solvent was removed was heated again and reused as dry air. At this time, the solvent was reused after the amount of water contained in the solvent was adjusted to be equal to or less than 0.5%.

The stripped film was transported by a transfer portion provided with a plurality of rollers. The transfer portion had three rollers, and the temperature of the transfer portion was kept at 40° C. While the film was being transported by the rollers of the transfer portion, a tension of 16 N to 160 N was applied thereto.

(Condition of Tenter Transport/Drying Process)

In a state in which both ends of the stripped film were fixed by the tenter having clips, the film was transported into a drying zone of the tenter and dried by the dry air. The clips were supplied with a heating medium at 20° C. and cooled. The tenter was driven by a chain, and the fluctuation in speed of a sprocket thereof was equal to or less than 0.5%. Furthermore, the inside of the tenter was divided into three zones, and the temperatures of the dry air of the respective zones were 90° C., 100° C., and 110° C. from the upstream side. The gas of the dry air was composed such that the gas had a saturated concentration at −10° C. The average drying speed in the tenter was 120% by mass (amount of solvent on dry basis)/min. The conditions of the drying zones were adjusted such that the amount of the residual solvent in the film became equal to or less than 10% by mass in the outlet of the tenter and became 7% by mass in the manufacturing of the present film. In the tenter, the film was stretched in the width direction while being transported. Herein, the film was stretched such that the width thereof increased 103% (stretch ratio of 3%) when the width of the film just transported to the tenter was regarded as being 100%. The stretch ratio (tenter driving draw) from the strip roller to the inlet of the tenter was 102%. Regarding the stretch ratio in the tenter, a difference of a substantial stretch ratio in a portion separated from a biting portion of the tenter by a distance of equal to or greater than 10 mm was equal to or less than 10%, and a difference in the stretch ratio between any two points separated from each other by 20 mm was equal to or less than 5%.

In the base end, the proportion of the length of the portion fixed by the tenter was 90%. Moreover, the film was transported while being cooled such that the temperature of the tenter clip did not exceed 50° C. The solvent evaporated from the tenter portion was liquefied by being condensed at a temperature of −10° C. and recovered. For condensing and recovering, a condenser was provided, and the temperature of the outlet thereof was set to be −8° C. The amount of water contained in the solvent was adjusted to be equal to or less than 0.5% by mass, and then, the solvent was reused.

Thereafter, within 30 seconds after the film came out of the outlet of the tenter, edge cutting was performed on both ends of the film. By using an NT-type cutter, the edge of 50 mm from both sides was cut. The oxygen concentration in the dry atmosphere of the tenter portion was kept at 5 vol %, and in order to keep the oxygen concentration at 5 vol %, air was purged by nitrogen gas. Before being dried at a high temperature in a roller transport zone which will be described later, the film was preheated in a preheating zone supplied with dry air at 100° C.

(Condition of Post-Drying Process)

The polymer film which was obtained by the aforementioned method and underwent the edge cutting was dried at a high temperature in a roller transport zone. The roller transport zone was divided into four sections, and the sections were supplied with dry air at 120° C., 130° C., 130° C., and 130° C., respectively, from the upstream side. At this time, a roller transport tension of the film was set to 100 N/width, and the film was dried for about 10 minutes until the amount of the residual solvent finally became 0.3% by mass. As the wrap angle of the rollers, 90° and 180° were used. The rollers were made of a material such as aluminum or carbon steel, and the surface thereof was plated with hard chromium. As the rollers, a roller having a flat surface shape and a roller having a surface shape subjected to matting processing by blasting were used. The run out resulting from the rotation of the roller was equal to or less than 50 μm in all rollers. Furthermore, the roller deflection at a tension of 100 N/width was set such that it became equal to or less than 0.5 mm.

In the process, a forced static elimination apparatus (static eliminator bar) was installed such that the charged electrostatic voltage of the film being transported was within a range of −3 kV to 3 kV all the time. Moreover, in a winding-up portion, in addition to the static eliminator bar, an ionic-wind static elimination apparatus was installed such that the charged electrostatic voltage of the film was within a range of −1.5 kV to 1.5 kV.

The dried film was transported to a first humidity conditioning chamber. The transfer portion between the roller transport zone and the first humidity conditioning chamber was supplied with dry air at 110° C. The first humidity conditioning chamber was supplied with air which was at a temperature of 50° C. and had a dew point temperature of 20° C. Then, the film was transported to a second humidity conditioning chamber for inhibiting curling of the film. In the second humidity conditioning chamber, the film was directly exposed to air of a temperature of 90° C. and a relative humidity of 70%.

(Condition of Post-Processing and Winding Up)

The dried polymer film was cooled to a temperature equal to or less than 30° C., and edge cutting was performed on both ends thereof. For the edge cutting, two apparatuses for slitting the end of the film were installed in both the left and right ends of the film (two slitting apparatuses were installed in each side), and the ends of the film were slit. The slitting apparatus was constituted with a discoid rotating upper blade and a roll-like rotating lower blade. The material of the rotating upper blade was super-hard steel, the diameter of the rotating upper blade was 200 mm, and the thickness of the edge of the cut site thereof was 0.5 mm. The material of the roll-like rotating lower blade was super-hard steel, and the roll diameter of the rotating lower blade was 100 mm.

As a result of measuring the surface roughness (arithmetic mean roughness: Ra) of the surface of the slit film, a surface roughness of 0.2 μm was obtained. The cross-section of the slit film was relatively smooth, and no chips were generated. Moreover, during the formation of the cellulose ester film, the film was not ruptured at all while being transported.

The surface roughness of the film surface was measured by using a surface profiler (NewView 5010) manufactured by ZYGO Corporation under apparatus conditions of a 50× object lens and 1.3× image zooming. In this case, the measurement conditions were appropriately set by using a Mesure Cntrl key, and the measured data was subjected to data processing by appropriately setting an Analyze Cntrl key.

In this manner, a transparent cellulose acylate support having a width of 1,500 mm and a film thickness of 40 μm was obtained and wound up by using a winding-up machine.

Furthermore, the rate of dimensional change of the site having a width of 20 mm from the film end of the slit transparent cellulose acylate support was measured. The rate of dimensional change was evaluated by calculating a percentage of a dimension (a length in the width direction) changed after the support was held for 120 hours in an environment at a temperature of 90° C. and a relative humidity of 5%, with respect to a dimension (a length in the width direction) of the transparent cellulose acylate support immediately after the manufacturing thereof. As a result, the rate of dimensional change of the site having a width of 20 mm from the end of the transparent cellulose acylate support was −0.13% which was unproblematic.

Moreover, both ends of the transparent cellulose acylate support were subjected to knurling. Knurs were formed by performing embossing processing from one side of the support, and the width of the portion subjected to the knurling was 10 mm. The pressing force was set such that the maximum height of the knur became 12 μm greater than the average thickness on average.

Then the film was transported to winding-up chamber. The winding-up chamber was kept at an internal temperature of the chamber of 25° C. and a humidity of 60%. The width of the product of the transparent cellulose acylate support obtained in this manner was 1,500 mm. The diameter of the winding core was 169 mm, and the tension pattern was set such that a tension of 390 N/width was applied at the beginning of winding and a tension of 250 N/width was applied at the end of winding. The total length of the film wound up was 3,250 m. The oscillation period at the time of winding up was set to be 400 m, and the oscillation width was set to be ±5 mm. Furthermore, the pressing force applied to a winding-up roll by a press roll was set to be 50 N/width. The transparent cellulose acylate support at the time of winding up had a temperature of 25° C. and contained 0.8% by mass of water and 0.2% by mass of residual solvent. Throughout the entire process, the average drying speed was 20% by mass (amount of solvent on dry basis)/min. The wound film was not slackened, did not have wrinkle, and did not experience winding deviation even when subjected to an impact test under 10 G. The exterior of the roll was also excellent. Through the aforementioned processes, a transparent cellulose acylate support was prepared. The roll of the transparent cellulose acylate support was stored on a storage rack at a temperature of 25° C. and a relative humidity of 55% for 1 month, and then examined in the same manner as described above. As a result, no significant change was confirmed in all of the examination items, and no adhesion was observed in the roll. Furthermore, after the film of the transparent cellulose acylate support was formed, the peeling residue of the casting film formed of the dope was not observed on the endless belt as the metal support.

### Example 12

A transparent support having a film thickness of 40 μm was formed in the same manner as in Example 6, except that the aforementioned additive (PB-33) was added in an amount of 10 parts by mass to the dope of Example 6 per 100 parts by mass of cellulose acylate, and the film was stretched 25% in the TD direction. Except for these, an optical laminate was prepared in the same manner as in Example 6.

### Comparative Example 1

A transparent cellulose acetate support was prepared in the same manner as in Example 1, except that the thickness of the support was changed to 5 μm. By using the support, an optical laminate was prepared in the same manner as in Example 1.

### Comparative Example 2

A transparent cellulose acetate support was prepared in the same manner as in Example 6, except that the makeup of the dope for a core layer used for preparing the transparent support of Example 6 was changed to the following makeup, the flow rates of the respective dopes were adjusted such that the thickness ratio at the time of forming a film by co-casting became air layer/core layer/support layer=3/54/3, and the thickness of the support was changed to 60 μm. By using the support, an optical laminate was prepared in the same manner as in Example 1.

Makeup of dope for core layer

| | | |
|---|---|---|
| Cellulose acetate (degree of acetylation of 2.86, | 100 | parts by mass |
| number-average molecular weight of 72,000) | | |
| Methylene chloride (first solvent) | 320 | parts by mass |
| Methanol (second solvent) | 83 | parts by mass |
| 1-Butanol (third solvent) | 3 | parts by mass |
| Triphenyl phosphate | 8.3 | parts by mass |
| Biphenyl diphenyl phosphate | 4.2 | parts by mass |
| The following compound 1 | 0.98 | parts by mass |
| The following compound 2 | 0.24 | parts by mass |

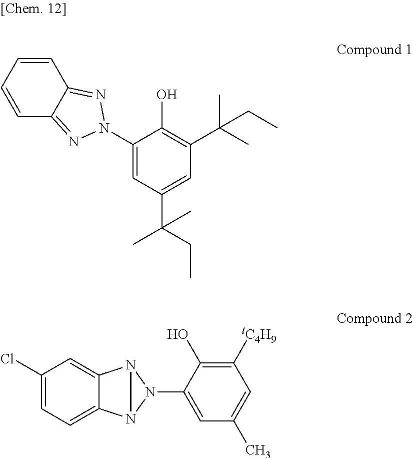

### Comparative Example 3

An optical laminate was prepared in the same manner as in Example 7, except that the film 3 (thickness: 80 μm) described in paragraphs [0072] to [0075] and [0097] of JP 2012-108452 A was used as a transparent support.

### Comparative Example 4

A transparent support having a film thickness of 40 μm was formed in the same manner as in Example 6, except that the plasticizers (triphenyl phosphate and biphenyl diphenyl phosphate) were not added to the dope of Example 6, and the film was stretched 25% in the TD direction. Except for this, an optical laminate was prepared in the same manner as in Example 6.

### Comparative Example 5

A transparent support having a film thickness of 80 μm was formed in the same manner as in Example 6, except that the plasticizers (triphenyl phosphate and biphenyl diphenyl phosphate) were not added to the dope of Example 6, and the film was stretched 25% in the TD direction. Except for this, an optical laminate was prepared in the same manner as in Example 5.

<Δ Moisture Content>

Ten optical laminates were prepared for each of the examples and comparative examples. For each of the ten optical laminates, the Δ moisture content defined by the following Equations (1) and (2) was calculated, and the average thereof was determined. The results are shown in the following Table 1.

For measuring the moisture content, samples obtained by cutting the optical laminates in a size of 24 mm×36 mm were prepared, and the moisture content was measured by the Karl Fischer method by using a moisture content measuring instrument (CA-03, manufactured by Mitsubishi Chemical Corporation) and a sample drying apparatus (VA-05, manufactured by Mitsubishi Chemical Corporation). The moisture content was calculated by dividing the amount of water (g) by the mass (g) of the sample.

(1) Δ moisture content [% by mass]=a moisture content measured after the optical laminate is left in an environment of a temperature of 25° C. and a relative humidity of 40% for 336 hours, and then moved to an environment of a temperature of 25° C. and a relative humidity of 60% and left therein for 300 minutes

a moisture content measured after the optical laminate is left in an environment of a temperature of 25° C. and a relative humidity of 40% for 336 hours.

(2) The moisture content [% by mass]=an amount of water contained in the optical laminate/mass of the optical laminate

[Preparation of Stereoscopic Display Apparatus]

From a polarizing plate at the visible side of LW5700 (42 inches) manufactured by LG ELECTRONICS, an adhesive film and the like laminated on the outside of the polarizing plate were peeled. Then, each of the optical laminates prepared as above was left in an environment at a temperature of 25° C. and a relative humidity of 60% for 300 minutes. Thereafter, the release film of the optical laminate was peeled, and the optical laminate was stuck on the polarizing plate in the same environment, thereby preparing a stereoscopic display apparatus. In this panel, a stripe-like pattern was formed in the horizontal direction.

At this time, the angle formed between the slow axis of the patterned optically anisotropic layer and the absorption axis of the polarizing plate was controlled to be ±45°.

The prepared stereoscopic display apparatus was caused to display an image for stereoscopic vision. The stereoscopic image was observed through circular polarization spectacles for the right eye/left eye, and evaluated in terms of the positional deviation, the vertical viewing angle, and the horizontal viewing angle by the methods described below. The results are shown in the following Table 1. Herein, the evaluation results shown in the following Table 1 were obtained by preparing ten stereoscopic display apparatuses and averaging the evaluation results thereof.

<Measurement of Positional Deviation>

It was checked that the length of the whole pixel region of the panel in the vertical direction was the same as the length of the whole region of the optically anisotropic layer in the vertical direction, and then, marks were made at the top and bottom of the whole region of the optically anisotropic layer. The distance between the marks was measured before and after sticking, and the difference was taken as positional deviation. The evaluation criteria are shown below.

AA: positional deviation is less than 0.005%.

A: positional deviation is equal to or greater than 0.005% and less than 0.010%.

B: positional deviation is equal to or greater than 0.010% and less than 0.015%.

C: positional deviation is equal to or greater than 0.015% and less than 0.020% (though positional deviation is observed, it is allowable).

D: positional deviation is equal to or greater than 0.020% and less than 0.030% (positional deviation is serious and not allowable).

DD: positional deviation is equal to or greater than 0.030%.

<Measurement of Vertical Viewing Angle>

The prepared stereoscopic display apparatus was caused to display a white stereoscopic image as a right-eye image on the whole screen and to display a black stereoscopic image as a left-eye image on the whole screen. Thereafter, a right-eye portion of 3D spectacles was mounted on the lens of a brightness photometer BM-5A manufactured by TOPCON TECHNOHOUSE CORPORATION, and brightness was measured in the vertical direction within a range of a polar angle +80° to a polar angle −80°.

Similarly, a left-eye portion of 3D spectacles was mounted on the lens of a brightness photometer BM-5A manufactured by TOPCON TECHNOHOUSE CORPORATION, and brightness was measured in the vertical direction within a range of a polar angle +80° to a polar angle −80°.

Then a value, which was obtained by dividing the brightness measured by the left-eye portion of the 3D spectacles with the brightness measured by the right-eye portion of the 3D spectacles, was taken as crosstalk, and the range of a polar angle in which the crosstalk became equal to or less than /% was defined as a viewing angle.

Based on the vertical viewing angle of LW5700 manufactured by LG ELECTRONICS, the extent to which the vertical viewing angle was narrowed was obtained by calculation. For example, provided that the vertical viewing angle before peeling is 26°, when the degree to which the vertical viewing angle generated by the positional deviation is narrowed is 2.6°, an outcome of “10%” can be calculated. The evaluation criteria are shown below.

A: less than 10% (substantially no change is visually recognized, and it is allowable.)

B: equal to or greater than 10% and less than 20% (a slight change was visually recognized, and it is allowable.)

C: equal to or greater than 20% and less than 35% (a change is visually recognized, but it is allowable.)

D: equal to or greater than 35% (an apparent change is visually recognized, and it is not allowable.)

<Measurement of Horizontal Viewing Angle>

The prepared stereoscopic display apparatus was caused to display a white stereoscopic image as a right-eye image on the whole screen and to display a black stereoscopic image as a left-eye image on the whole screen. Thereafter, a right-eye portion of 3D spectacles was mounted on the lens of a brightness photometer BM-5A manufactured by TOPCON TECHNOHOUSE CORPORATION, and brightness was measured in the horizontal direction within a range of a polar angle +80° to a polar angle −80°.

Similarly, a left-eye portion of 3D spectacles was mounted on the lens of a brightness photometer BM-5A manufactured by TOPCON TECHNOHOUSE CORPORATION, and brightness was measured in the horizontal direction within a range of a polar angle +80° to a polar angle −80°.

Then a value, which was obtained by dividing the brightness measured by the left-eye portion of the 3D spectacles with the brightness measured by the right-eye portion of the 3D spectacles, was taken as crosstalk, and the range of a polar angle in which the crosstalk became equal to or less than 7% was defined as a viewing angle. The measurement results were evaluated based on the following criteria.

A: equal to or greater than 160°

B: equal to or greater than 150° and less than 160°

C: equal to or greater than 140° and less than 150°

D: less than 140°

TABLE 1

| | Transparent support | | | | | | | | | | |
|---|---|---|---|---|---|---|---|---|---|---|---|
| | | | Rate of | | Lamination portion | | Optical | Panel evaluation | | | |
| | | | humidity- | | (Optical film) | | laminate | Positional deviation | | | |
| | Thick- | Elastic | induced | Optically | | \|ΔRth | Δ Moisture | Actually | | Vertical | Horizontal |
| | ness | modulus | dimensional | anisotropic | \|Rth(550)\| | (30-80% RH)\| | content | measured | Eval- | viewing | viewing |
| | [μm] | [GPa] | change [%] | layer | [nm] | (550 nm) [nm] | [wt %] | value | uation | angle | angle |
| Example 1 | 15 | 3.4 | 0.50 | DLC | 47 | 26 | 0.20 | 0.016% | C | C | B |
| Example 2 | 20 | 3.3 | 0.48 | DLC | 44 | 28 | 0.20 | 0.011% | B | B | B |
| Example 3 | 25 | 3.5 | 0.49 | DLC | 35 | 25 | 0.19 | 0.008% | A | A | A |
| Example 4 | 30 | 3.4 | 0.48 | DLC | 30 | 27 | 0.18 | 0.005% | A | A | A |
| Example 5 | 30 | 3.8 | 0.39 | RLC | 96 | 36 | 0.18 | 0.005% | A | A | C |
| Example 6 | 40 | 3.5 | 0.46 | DLC | 25 | 26 | 0.17 | 0.007% | A | A | A |
| Example 7 | 40 | 3.7 | 0.40 | RLC | 102 | 35 | 0.17 | 0.007% | A | A | C |
| Example 8 | 40 | 3.1 | 0.25 | RLC | 72 | 1 | 0.09 | 0.003% | AA | A | B |
| Example 9 | 40 | 2.4 | 0.05 | RLC | 71 | 1 | 0.02 | 0.002% | AA | A | B |
| Example 10 | 50 | 3.8 | 0.39 | RLC | 106 | 37 | 0.16 | 0.014% | B | B | C |
| Example 11 | 40 | 4.5 | 0.44 | RLC | 182 | 12 | 0.16 | 0.006% | A | A | D |
| Example 12 | 40 | 3.5 | 0.44 | DLC | 24 | 26 | 0.11 | 0.003% | AA | A | A |
| Comparative | 5 | 3.2 | 0.45 | DLC | 54 | 25 | 0.22 | 0.030% | DD | D | B |
| example 1 | | | | | | | | | | | |
| Comparative | 60 | 3.5 | 0.50 | DLC | 15 | 28 | 0.15 | 0.021% | D | D | A |
| example 2 | | | | | | | | | | | |
| Comparative | 80 | 3.3 | 0.45 | RLC | 137 | 25 | 0.13 | 0.029% | D | D | D |
| example 3 | | | | | | | | | | | |
| Comparative | 40 | 5.0 | 0.50 | DLC | 26 | 26 | 0.28 | 0.021% | D | D | A |
| example 4 | | | | | | | | | | | |
| Comparative | 80 | 5.0 | 0.50 | RLC | 131 | 25 | 0.23 | 0.045% | DD | D | D |
| example 5 | | | | | | | | | | | |

From the results shown in Table 1, it was found that when the optical laminates prepared in Comparative examples 2 and 3 in which the thickness of the transparent support was out of the range of 10 μm to 59 μm were used, even if the Δ moisture content was equal to or less than 0.20% by mass, positional deviation occurred when the optical laminate was stuck on the display apparatus, and the vertical viewing angle deteriorated.

Moreover, it was found that the optical laminate prepared in Comparative example 4, in which the Δ moisture content was greater than 0.20% by mass, caused positional deviation when stuck on the display apparatus, even if the thickness of the transparent support was within a range of 10 μm to 59 μm.

Furthermore, it was found that the optical laminates prepared in Comparative examples 1 and 5, in which the thickness of the transparent support was out of the range of 10 μm to 59 μm and the Δ moisture content was greater than 0.20% by mass, caused serious positional deviation when stuck on the display apparatus, and the vertical viewing angle and the horizontal viewing angle deteriorated.

In contrast, it was found that Examples 1 to 12 in which the thickness of the transparent support was within a range of 10 μm to 59 μm could be stuck on the display apparatus with high accuracy, and the vertical viewing angle of the display apparatus could be improved after the optical laminate was stuck on the display apparatus.

Particularly, from the comparison between Examples 1 to 10 as well as 12 and 11, it was found that if the absolute value of Rth (550) in the laminated Portion (optical film) is equal to or less than 120 nm, the horizontal viewing angle can be improved.

Moreover, from the comparison between Examples 5, 7, as well as 10 and other examples, it was found that if the absolute value of ΔRth (30% RH-80% RH) in the laminated portion (optical film) is equal to or less than 30 nm, the horizontal viewing angle can be improved.

In addition, from the comparison between Examples 8, 9, as well as 12 and other examples, it was found that an optical laminate with a low Δ moisture content could be stuck on a display apparatus with higher accuracy.

What is claimed is:

1. An optical laminate comprising:
a surface protection film;
a transparent support;
an optically anisotropic layer;
an adhesive layer; and
a release film in this order,
wherein the optically anisotropic layer is a patterned optically anisotropic layer which includes a first phase difference region and a second phase difference region differing from each other in terms of the direction of an in-plane slow axis and in which the first and second phase difference regions are alternately disposed within a plane of the optically anisotropic layer,
the transparent support contains a polymer material and has a thickness of 10 μm to 59 μm, and
a Δ moisture content defined by the following Equations (1) and (2) is equal to or less than 0.20% by mass.
Δ moisture content [% by mass]=a moisture content measured after the optical laminate is left in an environment of a temperature of 25° C. and a relative humidity of 40% for 336 hours, and then moved to an environment of a temperature of 25° C. and a relative humidity of 60% and left therein for 300 minutes (1)
a moisture content measured after the optical laminate is left in an environment of a temperature of 25° C. and a relative humidity of 40% for 336 hours.
The moisture content [% by mass]=an amount of water contained in the optical laminate/mass of the optical laminate (2)

2. The optical laminate according to claim 1,
wherein in the transparent support, an elastic modulus of a disposition direction in which the first and second phase difference regions of the optically anisotropic layer are alternately disposed is 1.5 GPa to 5.0 GPa.

3. The optical laminate according to claim 1,
wherein in the transparent support, a rate of humidity-induced dimensional change in the disposition direction in which the first and second phase difference regions of the optically anisotropic layer are alternately disposed is 0.03% to 0.50%.

4. The optical laminate according to claim 2,
wherein in the transparent support, a rate of humidity-induced dimensional change in the disposition direction in which the first and second phase difference regions of the optically anisotropic layer are alternately disposed is 0.03% to 0.50%.

5. The optical laminate according to claim 1,
wherein a laminated portion comprising the transparent support and the optically anisotropic layer satisfies the following Expression (I),

|Rth(550)|≦120 nm, (I)
herein, Rth (550) is retardation (nm) in the thickness direction at a wavelength of 550 nm.

6. The optical laminate according to claim 2,
wherein a laminated portion comprising the transparent support and the optically anisotropic layer satisfies the following Expression (I),

|Rth(550)|≦120 nm, (I)
herein, Rth (550) is retardation (nm) in the thickness direction at a wavelength of 550 nm.

7. The optical laminate according to claim 3,
wherein a laminated portion comprising the transparent support and the optically anisotropic layer satisfies the following Expression (I),

|Rth(550)|≦120 nm, (I)
herein, Rth (550) is retardation (nm) in the thickness direction at a wavelength of 550 nm.

8. The optical laminate according to claim 4,
wherein a laminated portion comprising the transparent support and the optically anisotropic layer satisfies the following Expression (I),

|Rth(550)|≦120 nm, (I)
herein, Rth (550) is retardation (nm) in the thickness direction at a wavelength of 550 nm.

9. The optical laminate according to claim 1,
wherein the laminated portion comprising the transparent support and the optically anisotropic layer satisfies the following Expression (II),

|ΔRth(30% RH-80% RH)|≦30 nm, (II)
herein, ΔRth (30% RH-80% RH) is a difference between Rth (550) measured at a relative humidity of 30% and Rth (550) measured at a relative humidity of 80%.

10. The optical laminate according to claim 2,
wherein the laminated portion comprising the transparent support and the optically anisotropic layer satisfies the following Expression (II),

|ΔRth(30% RH-80% RH)|≦30 nm, (II)
herein, ΔRth (30% RH-80% RH) is a difference between Rth (550) measured at a relative humidity of 30% and Rth (550) measured at a relative humidity of 80%.

11. The optical laminate according to claim 3,
wherein the laminated portion comprising the transparent support and the optically anisotropic layer satisfies the following Expression (II),

|ΔRth(30% RH-80% RH)|≦30 nm, (II)
herein, ΔRth (30% RH-80% RH) is a difference between Rth (550) measured at a relative humidity of 30% and Rth (550) measured at a relative humidity of 80%.

12. The optical laminate according to claim 4,
wherein the laminated portion comprising the transparent support and the optically anisotropic layer satisfies the following Expression (II),

|ΔRth(30% RH-80% RH)|≦30 nm, (II)
herein, ΔRth (30% RH-80% RH) is a difference between Rth (550) measured at a relative humidity of 30% and Rth (550) measured at a relative humidity of 80%.

13. The optical laminate according to claim 5,
wherein the laminated portion comprising the transparent support and the optically anisotropic layer satisfies the following Expression (II),

|ΔRth(30% RH-80% RH)|≦30 nm, (II)
herein, ΔRth (30% RH-80% RH) is a difference between Rth (550) measured at a relative humidity of 30% and Rth (550) measured at a relative humidity of 80%.

14. The optical laminate according to claim 6,
wherein the laminated portion comprising the transparent support and the optically anisotropic layer satisfies the following Expression (II),

|ΔRth(30% RH-80% RH)|≦30 nm, (II)
herein, ΔRth (30% RH-80% RH) is a difference between Rth (550) measured at a relative humidity of 30A and Rth (550) measured at a relative humidity of 80%.

15. The optical laminate according to claim 7,
wherein the laminated portion comprising the transparent support and the optically anisotropic layer satisfies the following Expression (II),

|ΔRth(30% RH-80% RH)|≦30 nm, (II)
herein, ΔRth (30% RH-80% RH) is a difference between Rth (550) measured at a relative humidity of 30% and Rth (550) measured at a relative humidity of 80%.

16. The optical laminate according to claim 8,
wherein the laminated portion comprising the transparent support and the optically anisotropic layer satisfies the following Expression (II),

|ΔRth(30% RH-80% RH)|≦30 nm, (II)
herein, ΔRth (30% RH-80% RH) is a difference between Rth (550) measured at a relative humidity of 30% and Rth (550) measured at a relative humidity of 80%.

17. The optical laminate according to claim 1,
wherein the polymer material contained in the transparent support contains at least cellulose acylate.

18. The optical laminate according to claim 1,
wherein the release film is a biaxially oriented polyester film having a thickness of 10 μm to 100 μm.

19. The optical laminate according to claim 1,
wherein the surface protection film is a biaxially oriented polyester film having a thickness of 20 μm to 100 μm.

20. The optical laminate according to claim 1,
wherein the optically anisotropic layer is formed of a composition containing a rod-like liquid crystal.

21. The optical laminate according to claim 1,
wherein the optically anisotropic layer is formed of a composition containing a discotic liquid crystal.
